(19) United States
(12) Patent Application Publication
(10) Pub. No.: US 2019/0096135 A1
(43) Pub. Date: Mar. 28, 2019

(54) SYSTEMS AND METHODS FOR VISUAL INSPECTION BASED ON AUGMENTED REALITY

(71) Applicant: AQUIFI, INC., Palo Alto, CA (US)

(72) Inventors: Carlo Dal Mutto, Sunnyvale, CA (US); Jason Trachewsky, Menlo Park, CA (US); Tony Zuccarino, Saratoga, CA (US)

(21) Appl. No.: 16/143,400

(22) Filed: Sep. 26, 2018

Related U.S. Application Data
(60) Provisional application No. 62/563,560, filed on Sep. 26, 2017.

(51) Int. Cl. G06T 19/00; G06T 19/20; G06T 7/73; G06T 7/00; G06T 7/11; G06T 7/50; G06K 9/62; G02B 27/01; G06T 17/00

(52) U.S. Cl. CPC G06T 19/006; G06T 2200/08; G06T 7/73; G06T 7/0006; G06T 7/001; G06T 7/11; G06T 7/50; G06K 9/6267; G06K 9/626; G06K 9/6257; G02B 27/0172; G06T 17/00; G06T 2219/2016; G06T 2219/2004; G06T 2207/10028; G06T 2207/20081; G06T 2207/20084; G06K 2209/27; G06T 2219/2012; G06T 2207/10008; G02B 2027/0138; G02B 2027/014; G02B 2027/0141; G06T 19/20

(57) ABSTRACT

A system for visual inspection includes: a scanning system configured to capture images of an object and to compute a three-dimensional (3-D) model of the object based on the captured images; an inspection system configured to: compute a descriptor of the object based on the 3-D model of the object; retrieve metadata corresponding to the object based on the descriptor; and compute a plurality of inspection results based on the retrieved metadata and the 3-D model of the object; and a display device system including: a display; a processor; and a memory storing instructions that, when executed by the processor, cause the processor to: generate overlay data from the inspection results; and show the overlay data on the display, the overlay data being aligned with a view of the object through the display.

### CROSS-REFERENCE TO RELATED APPLICATION(S)

This application claims the benefit of U.S. Provisional Patent Application No. 62/563,560, “SYSTEMS AND METHODS FOR VISUAL INSPECTION BASED ON AUGMENTED REALITY,” filed in the United States Patent and Trademark Office on Sep. 26, 2017, the entire disclosure of which is incorporated by reference herein.

### FIELD

Aspects of embodiments of the present invention relate to the field of user interfaces for inspection systems.

### BACKGROUND

The problem of detecting anomalous or defective objects among a collection of different objects is common in a variety of contexts. For example, a quality assurance system may improve the quality of goods that are delivered to customers by detecting defective goods and delivering only non-defective goods to customers. As used herein, the terms “defect” and “defective” includes circumstances where a particular instance of an object differs from a defined specification (e.g., incorrectly sized or having some other difference). As discussed in more detail below, the defined specification may include one or more of: a canonical or reference model; one or more defect detectors such as trained convolutional neural networks; and one or more rules based comparisons of measurements with expected measurement values. As discussed in more detail below, some aspects of embodiments of the present invention relate to the detection of “abnormal” or “outlier” objects that deviate from the typical appearance of an object, where the typical appearance of an object is automatically determined from analyzing a large number of representative objects, such as a training set or an actual set.

As a specific example, when manufacturing shoes, it may be beneficial to inspect the shoes to ensure that the stitching is secure, to ensure that the sole is properly attached, and to ensure that the eyelets are correctly formed. This inspection is typically performed manually by a human inspector. The human inspector may manually evaluate the shoes and remove shoes that have defects. In some instances, where the goods are low cost such as when manufacturing containers (e.g., jars), it may be beneficial to inspect the containers to ensure that they are not cracked or punctured, and to ensure that various parts (e.g., screw threads of the jar) are formed properly, but it may not be cost effective for a human inspector to manually evaluate the containers.

Defect detection systems may also be used in other contexts, such ensuring that the customized goods are consistent with the specifications provided by a customer (e.g., that the color and size of a customized piece of clothing are consistent with what was ordered by the customer).

### SUMMARY

Aspects of embodiments of the present invention relate to the field of user interfaces for inspection systems. In more detail, aspects of embodiments of the present invention relate to scanning objects to obtain models of the objects, retrieving information and/or analyzing the scanned objects, overlaying information about objects onto a view of the object from the perspective of a user or from another vantage point such as a virtually reconstructed vantage point or the vantage point of a camera directed at the objects.

According to one embodiment of the present invention, a system for visual inspection includes: a scanning system configured to capture images of an object and to compute a three-dimensional (3-D) model of the object based on the captured images; an inspection system configured to: compute a descriptor of the object based on the 3-D model of the object; retrieve metadata corresponding to the object based on the descriptor; and compute a plurality of inspection results based on the retrieved metadata and the 3-D model of the object; and a display device system including: a display; a processor; and a memory storing instructions that, when executed by the processor, cause the processor to: generate overlay data from the inspection results; and show the overlay data on the display, the overlay data being aligned with a view of the object through the display.

The display device system may include an augmented reality head-mounted device (AR-HMD) including the display, and the display may be transparent to provide the view of the object.

The AR-HMD may include one or more sensing components configured to capture information about an environment near the AR-HMD and an orientation of the AR-HMD, and the memory may further store instructions that, when executed by the processor, cause the processor to: compute a relative pose of the object with respect to the view of the object through the display of the AR-HMD based on the information from the sensing components; and transform a position of the overlay data in the display in accordance with the relative pose of the object with respect to the view of the object through the display of the AR-HMD.

The one or more sensing components may include a depth camera.

The memory may further store instructions that, when executed by the processor, cause the processor to: detect a change in the relative pose of the object with respect to the view of the object through the display of the AR-HMD based on the information from the sensing components; and transform the position of the overlay data in accordance with the change in the relative pose of the object with respect to the view of the object through the display of the AR-HMD.

The display of the AR-HMD may include a left lens and a right lens, and the instructions to transform the position of the overlay data may include instructions that cause the processor to: compute a first position of the overlay data in accordance with the relative pose of the object with respect to a first view of the object through the left lens of the display of the AR-HMD; and compute a second position of the overlay data in accordance with the relative pose of the object with respect to a second view of the object through the right lens of the display of the AR-HMD.

The display device system may include a camera, the display may include a display panel, and the memory may further store instructions that, when executed by the processor, cause the processor to: control the camera to capture images of the object; and show the captured images of the object on the display to provide the view of the object.

The display device system may include one or more sensing components configured to capture information about an environment near the camera, and the memory may further store instructions that, when executed by the processor, cause the processor to: compute a relative pose of the object with respect to the view of the object through the display of the display device system based on the information from the sensing components; and transform a position of the overlay data in the display in accordance with the relative pose of the object with respect to the view of the object through the display of the display device system.

The memory may further store instructions that, when executed by the processor, cause the processor to: detect a change in the relative pose of the object with respect to the view of the object through the display of the display device system based on the information from the sensing components; and transform the position of the overlay data in accordance with the change in the relative pose of the object with respect to the view of the object through the display of the display device system.

The one or more sensing components may include the camera.

The plurality of inspection results may include defects detected by the inspection system.

The inspection system may be configured to detect defects by: retrieving, from the metadata, one or more expected measurement values of the object; measuring one or more measurement values of the 3-D model of the object; comparing the one or more measurement values with corresponding ones of the one or more expected measurement values; and detecting a defect when a measurement value of the one or more measurement values differs from a corresponding one of the one or more expected measurement values.

The inspection system may be configured to detect defects by: retrieving, from the metadata, a reference 3-D model of a canonical instance of a class corresponding to the object; aligning the 3-D model of the object with the reference 3-D model; comparing the 3-D model of the object to the reference 3-D model to compute a plurality of differences between corresponding regions of the 3-D model of the object and the reference 3-D model; and detecting one or more defects in the object when one or more of the plurality of differences exceeds a threshold.

The comparing the 3-D model of the object to the reference 3-D model my include: dividing the 3-D model of the object into a plurality of regions; identifying corresponding regions of the reference 3-D model; detecting locations of features in the regions of the 3-D model of the object; computing distances between detected features in the regions of the 3-D model of the object and locations of features in the corresponding regions of the reference 3-D model; and outputting the distances as the plurality of differences.

The reference 3-D model may be computed by: scanning a plurality of training objects corresponding to the class to generate a plurality of training 3-D models; removing outliers from the plurality of training 3-D models to generate a plurality of typical training 3-D models; and computing an average of the plurality of typical training 3-D models to generate the reference 3-D model.

The inspection system may be configured to detect defects by: retrieving, from the metadata, a convolutional stage of a convolutional neural network and a defect detector; rendering one or more views of the 3-D model of the object; computing a descriptor by supplying the one or more views of the 3-D model of the object to the convolutional stage of the convolutional neural network; supplying the descriptor to the defect detector to compute one or more defect classifications of the object; and outputting the one or more defect classifications of the object.

The inspection system may be configured to detect defects by: retrieving, from the metadata, one or more rules, each of the rules including an explicitly defined detector; rendering one or more views of the 3-D model of the object; and applying the explicitly defined detector of each of the one or more rules to the one or more views of the 3-D model of the object to compute one or more defect classifications of the object.

The inspection system may be configured to detect defects by: retrieving, from the metadata, a generative model trained based on a plurality of training 3-D models of a representative sample of non-defective objects; and supplying the 3-D model of the object to the generative model to compute one or more defect classifications of the object.

The defects may include location-specific defects, the inspection results may include a result 3-D model, the result 3-D model identifying a location of at least one defect of the object, and the memory may further store instructions that, when executed by the processor, cause the processor to: align the result 3-D model with the view of the object through the display; and show the result 3-D model overlaid on the view of the object through the display.

The result 3-D model may indicate a magnitude of the at least one defect at the location, and the magnitude may be shown as a color overlay on the view of the object through the display.

The memory may further store instructions that, when executed by the processor, cause the processor to show non-location specific information of the inspection results in association with the view of the object through the display.

According to one embodiment of the present invention, a method for visual inspection includes: capturing a plurality of images of an object using a scanning system; computing a three-dimensional (3-D) model of the object based on the plurality of images; computing, by an inspection system including a processor and memory, a descriptor of the object based on the 3-D model of the object; retrieving, by the inspection system, metadata corresponding to the object based on the descriptor; computing, by the inspection system, a plurality of inspection results based on the retrieved metadata and the 3-D model of the object; generating overlay data from the inspection results; and showing the overlay data on a display of a display device system, the overlay data being aligned with a view of the object through the display.

The display device system may include an augmented reality head-mounted device (AR-HMD) including the display, and the display may be transparent to provide the view of the object.

The AR-HMD may include one or more sensing components configured to capture information about an environment near the AR-HMD and an orientation of the AR-HMD, and the method may further include: computing, by the display device system, a relative pose of the object with respect to the view of the object through the display of the AR-HMD based on the information from the sensing components; and transforming a position of the overlay data in the display in accordance with the relative pose of the object with respect to the view of the object through the display of the AR-HMD.

The one or more sensing components may include a depth camera.

The method may further include: detecting a change in the relative pose of the object with respect to the view of the object through the display of the AR-HMD based on the information from the sensing components; and transforming the position of the overlay data in accordance with the change in the relative pose of the object with respect to the view of the object through the display of the AR-HMD.

The display of the AR-HMD may include a left lens and a right lens, and wherein the transforming the position of the overlay data may include: computing a first position of the overlay data in accordance with the relative pose of the object with respect to a first view of the object through the left lens of the display of the AR-HMD; and computing a second position of the overlay data in accordance with the relative pose of the object with respect to a second view of the object through the right lens of the display of the AR-HMD.

The display device system may include a camera, the display may include a display panel, and the method may further include: controlling the camera to capture images of the object; and showing the captured images of the object on the display to provide the view of the object.

The display device system may include one or more sensing components configured to capture information about an environment near the camera, and the method may further include: computing a relative pose of the object with respect to the view of the object through the display of the display device system based on the information from the sensing components; and transforming a position of the overlay data in the display in accordance with the relative pose of the object with respect to the view of the object through the display of the display device system.

The method may further include: detecting a change in the relative pose of the object with respect to the view of the object through the display of the display device system based on the information from the sensing components; and transforming the position of the overlay data in accordance with the change in the relative pose of the object with respect to the view of the object through the display of the display device system.

The one or more sensing components may include the camera.

The plurality of inspection results may include defects detected by the inspection system.

The inspection system may detect defects by: retrieving, from the metadata, one or more expected measurement values of the object; measuring one or more measurement values of the 3-D model of the object; comparing the one or more measurement values with corresponding ones of the one or more expected measurement values; and detecting a defect when a measurement value of the one or more measurement values differs from a corresponding one of the one or more expected measurement values.

The inspection system may detect defects by: retrieving, from the metadata, a reference 3-D model of a canonical instance of a class corresponding to the object; aligning the 3-D model of the object with the reference 3-D model; comparing the 3-D model of the object to the reference 3-D model to compute a plurality of differences between corresponding regions of the 3-D model of the object and the reference 3-D model; and detecting one or more defects in the object when one or more of the plurality of differences exceeds a threshold.

The comparing the 3-D model of the object to the reference 3-D model may include: dividing the 3-D model of the object into a plurality of regions; identifying corresponding regions of the reference 3-D model; detecting locations of features in the regions of the 3-D model of the object; computing distances between detected features in the regions of the 3-D model of the object and locations of features in the corresponding regions of the reference 3-D model; and outputting the distances as the plurality of differences.

The reference 3-D model may be computed by: scanning a plurality of training objects corresponding to the class to generate a plurality of training 3-D models; removing outliers from the plurality of training 3-D models to generate a plurality of typical training 3-D models; and computing an average of the plurality of typical training 3-D models to generate the reference 3-D model.

The inspection system may detect defects by: retrieving, from the metadata, a convolutional stage of a convolutional neural network and a defect detector; rendering one or more views of the 3-D model of the object; computing a descriptor by supplying the one or more views of the 3-D model of the object to the convolutional stage of the convolutional neural network; supplying the descriptor to the defect detector to compute one or more defect classifications of the object; and outputting the one or more defect classifications of the object.

The inspection system may detect defects by: retrieving, from the metadata, one or more rules, each of the rules including an explicitly defined detector; rendering one or more views of the 3-D model of the object; and applying the explicitly defined detector of each of the one or more rules to the one or more views of the 3-D model of the object to compute one or more defect classifications of the object.

The inspection system may detect defects by: retrieving, from the metadata, a generative model trained based on a plurality of training 3-D models of a representative sample of non-defective objects; and supplying the 3-D model of the object to the generative model to compute one or more defect classifications of the object.

The defects may include location-specific defects, the inspection results may include a result 3-D model, the result 3-D model identifying a location of at least one defect of the object, and the method may further include: aligning the result 3-D model with the view of the object through the display; and showing the result 3-D model overlaid on the view of the object through the display.

The result 3-D model may indicate a magnitude of the at least one defect at the location, and the magnitude may be shown as a color overlay on the view of the object through the display.

The method may further include showing non-location specific information of the inspection results in association with the view of the object through the display.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, together with the specification, illustrate exemplary embodiments of the present invention, and, together with the description, serve to explain the principles of the present invention.

FIG. 1A is an example of the display of information in an augmented reality head-mounted device (HMD) according to one embodiment of the present invention.

FIG. 1B is a block diagram of a system according to one embodiment of the present invention.

FIG. 1C is a flowchart of a method for analyzing an object and displaying analysis results according to one embodiment of the present invention.

FIG. 2 is a block diagram of a stereo depth camera system according to one embodiment of the present invention.

FIG. 3 is an example of a sequence of frames including depth maps and color images acquired by a depth camera that includes active stereo and at least one color camera.

FIG. 4A is a 2-D view of an example of a 3-D point cloud model, and FIG. 4B is a 2-D view of an example of a 3-D mesh model captured using one or more depth cameras.

FIG. 5A is a schematic diagram of a scanning system configured to scan objects on a conveyor belt according to one embodiment of the present invention.

FIG. 5B is a schematic diagram of an inspection system configured to display inspection data of objects on a conveyor belt according to one embodiment of the present invention.

FIG. 6 is a schematic depiction of an object (depicted as a handbag) traveling on a conveyor belt having two portions, where the first portion moves the object along a first direction and the second portion moves the object along a second direction that is orthogonal to the first direction in accordance with one embodiment of the present invention.

FIG. 7 is a schematic block diagram illustrating a process for capturing images of a target object and detecting defects in the target object according to one embodiment of the present invention.

FIG. 8 is a block diagram of an inspection system according to one embodiment of the present invention.

FIG. 9 is a flowchart of a method for analyzing a 3-D model of an object using an inspection system according to one embodiment of the present invention.

FIG. 10 is a flowchart of a method for computing a descriptor of a query object from a 3-D model of the query object according to one embodiment of the present invention.

FIG. 11 is a block diagram of a convolutional neural network based classification system according to one embodiment of the present invention.

FIGS. 12 and 13 are illustration of max-pooling according to one embodiment of the present invention.

FIG. 14 is a schematic diagram illustrating the analysis of a volumetric representation of a feature vector according to one embodiment of the present invention.

FIG. 15 is a flowchart of a method for detecting defects based on descriptors of locations of features of a target object according to one embodiment of the present invention.

FIG. 16 is a flowchart of a method for performing defect detection according to one embodiment of the present invention.

FIG. 17 is a flowchart illustrating a descriptor extraction stage and a defect detection stage according to one embodiment of the present invention.

FIG. 18 is a flowchart of a method for training a convolutional neural network according to one embodiment of the present invention.

FIG. 19 is a flowchart of a method for generating descriptors of locations of features of a target object according to one embodiment of the present invention.

FIG. 20 is a flowchart of a method for detecting defects based on descriptors of locations of features of a target object according to one embodiment of the present invention.

FIG. 21 is a block diagram of a display device system according to one embodiment of the present invention.

FIG. 22 is a flowchart illustrating a method for displaying the results of the analysis according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aggregation of visual information is one of the pillars of the smart factories envisioned by the current trend (“Industry 4.0”) of automation and data exchange in manufacturing technologies. Moreover, aggregation of visual information can also be applied to other fields that involve quality control and data analysis. Examples of such fields include logistics, maintenance, and system integration.

Aspects of embodiments of the present invention relate to systems and methods for visual inspection, including, but not limited to, systems configured to display inspection results using augmented reality (AR) user interfaces. As noted above, defect detection is a component of quality control in contexts such as manufacturing, where individual objects may be inspected and analyzed for compliance with particular quality standards. The inspection may typically be performed visually by a trained human inspector, who analyzes each manufactured object (or a representative sampling thereof) to assess compliance of the object with particular quality standards.

Automatic inspection of manufactured objects can automate inspection activities that might otherwise be performed manually by a human, and therefore can improve the quality control process by, for example, reducing or removing errors made by human inspectors, reducing the amount of time needed to inspect each object, and enabling the analysis of a larger number of produced objects (e.g., inspecting substantially all produced objects as opposed to sampling from the full set of the manufactured objects and inspecting only the manufactured subset).

Systems for automatic defect detection may supplement or augment the analysis performed by humans. In circumstances where the automatic defect detection systems augment the work of human inspectors, the results of the automatic analysis of the scanned objects may be presented to the human inspectors for further review.

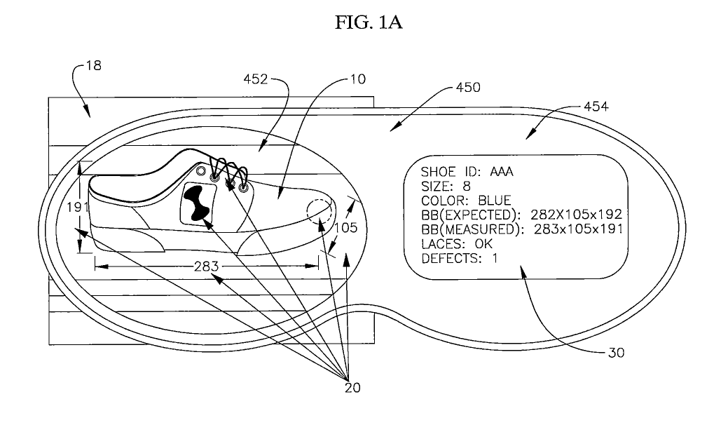

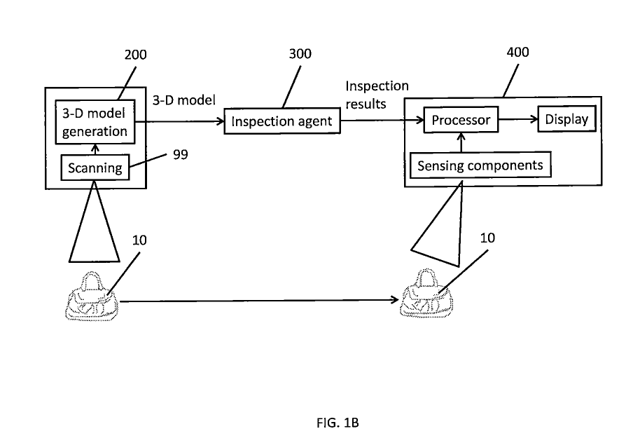

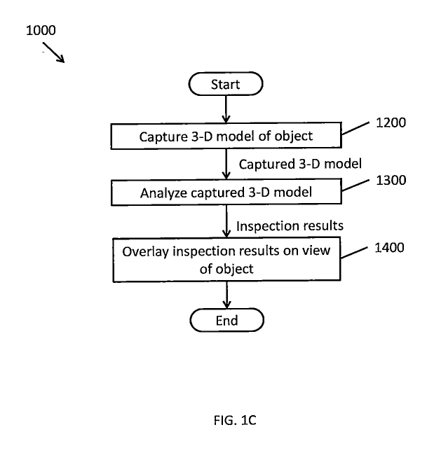

Some aspects of embodiments of the present invention relate to circumstances in which a physical object is automatically analyzed by an object inspection system or inspection agent and the results of the analysis are presented to a user (a human inspector). In some embodiments of the present invention, the results are shown on a display device such as a standard display panel (e.g., a computer monitor or a television) or using an augmented reality (AR) system such as a Head-Mounted Device (HMD). The display device provides a view of the inspected object with the analysis results of the inspection overlaid or otherwise displayed in connection with the view of the object. FIG. 1A is an example of the display of information 20 in an augmented reality head-mounted device (AR-HMD) according to one embodiment of the present invention, where the object 10 is visible through a transparent portion of the display device 450. In the example shown in FIG. 1, some information is overlaid 20 onto the view of the object, while other information is displayed adjacent 30 the view of the object 10 through the display device 450. For the sake of convenience of illustration, in the embodiment shown in FIG. 1, the object 10 is shown as viewed through the left lens 452 of the HMD (e.g., smart glasses) with the location specific information 20 overlaid on the object 10, while the right lens 454 of the HMD 450 shows non-location specific information 30. However, embodiments of the present invention are not limited thereto and may also include circumstances where the object is visible through both the left and right lenses and the location-specific and non-location-specific data are shown in one or both lenses.

An AR-HMD system 450 according to some embodiments of the present invention may be useful in circumstances where human inspectors need their hands for other tasks. For example, a human inspector may pick up an object under inspection (e.g., a shoe) in order to view the various portions of the object and to visualize portions of the object that may ordinarily be obscured (e.g., moving away the tongue of the shoe to inspect the insole). These situations are typical of manufacturing and logistics environments, and the benefit of overlaying an inspection graphical user interface (GUI) provides a direct association of the analysis results of the inspection system with the actual object being inspected. In addition, if there are multiple objects in view of the AR-HMD system, analysis results for each object in view (e.g., visible through the display device) may be concurrently displayed in association with the corresponding objects (e.g., overlaid or displayed adjacent the object).

Some aspects of embodiments of the present invention are implemented using a captured three-dimensional (3-D) model of the object to be inspected. FIG. 1B is a block diagram of a system according to one embodiment of the present invention. FIG. 1C is a flowchart of a method for analyzing an object and displaying analysis results according to one embodiment of the present invention. As shown in FIGS. 1B and 1C, the system includes a 3-D scanning system 100, which is configured to capture images of an object and a 3-D model generation system 200 configured to generate a 3-D model of the object from the images captured by the scanning system 100 in operation 1200. An inspection agent 300 computes measurements of the object based on the captured 3-D model in operation 1300. For example, a 3-D model enables the measurement of quantitative values and qualitative attributes of an object (e.g., quantitative values such as the length and width of a shoe or the location of a logo on the shoe and qualitative attributes such as the detection of features that present a clear geometric signature, such as the presence of wrinkles on leather).

The analysis results generated by the inspection agent 300 are displayed using a display device system 400 in operation 1400. The captured 3-D model of the object also helps in the case of visualization, because it enables the alignment of the overlay of the measured quantities with the view of the scene 18 in which the object is situated (e.g., through transparent lenses of AR-HMD glasses or on a display panel displaying a real-time video image of objects as the objects pass by a camera, as described in more detail below). The captured 3-D model may also be used to generate a result 3-D model, which can be used to visualize the locations of various defects and/or detected values and attributes of the object by rendering an aligned version of the model and overlaying the data over the view. The alignment of the overlay with the view is performed by calculating a relative pose between the object and the view of the object from the current perspective, and the relative pose may be captured using, for example, additional cameras and/or depth sensors, as described in more detail below.

Three-Dimensional Scanning

Some aspects of embodiments of the present invention relate to gathering geometric (shape) and/or color information about the object itself, possibly from multiple different vantage points (poses) with respect to the object. Collecting these views of the object can provide the data for performing a comprehensive inspection of the underlying objects. This procedure of capturing views of an object is sometimes referred to as three-dimensional scanning or three-dimensional modeling and can be effectively accomplished using a 3-D modeling system, which can include one or more 3-D scanners, each of which may include one or more depth cameras.

A three-dimensional scanner is a system that is able to acquire a 3-D model of a scene from visual information in the form of one or more streams of images. In one embodiment, a three-dimensional scanner includes one or more depth cameras, where a depth camera may include one or more color cameras, which acquire the color information about an object, and one or more Infra-Red (IR) cameras which may be used in conjunction with an IR structured-light illuminator to capture geometry information about the object. The special case in which there are two IR cameras and an IR structured-light illuminator is called active stereo, and allows for simultaneous scanning from multiple depth cameras with overlapping fields-of-view. The color and the infrared cameras are synchronized and geometrically calibrated, allowing these cameras to capture sequences of frames that are constituted by color images and depth-maps, for which it is possible to provide geometrical alignment. One example of a depth camera including two IR cameras, an IR structured light illuminator, and one color camera is described in U.S. Pat. No. 9,674,504, “DEPTH PERCEPTIVE TRINOCULAR CAMERA SYSTEM,” issued by the United States Patent and Trademark Office on Jun. 6, 2017, the entire disclosure of which is incorporated by reference herein.

In some embodiments of the present invention, the range cameras 100, also known as “depth cameras,” include at least two standard two-dimensional cameras that have overlapping fields of view. In more detail, these two-dimensional (2-D) cameras may each include a digital image sensor such as a complementary metal oxide semiconductor (CMOS) image sensor or a charge coupled device (CCD) image sensor and an optical system (e.g., one or more lenses) configured to focus light onto the image sensor. The optical axes of the optical systems of the 2-D cameras may be substantially parallel such that the two cameras image substantially the same scene, albeit from slightly different perspectives. Accordingly, due to parallax, portions of a scene that are farther from the cameras will appear in substantially the same place in the images captured by the two cameras, whereas portions of a scene that are closer to the cameras will appear in different positions.

Using a geometrically calibrated depth camera, it is possible to identify the 3-D locations of all visible points on the surface of the object with respect to a reference coordinate system (e.g., a coordinate system having its origin at the depth camera). Thus, a range image or depth image captured by a range camera 100 can be represented as a “cloud” of 3-D points, which can be used to describe the portion of the surface of the object (as well as other surfaces within the field of view of the depth camera).

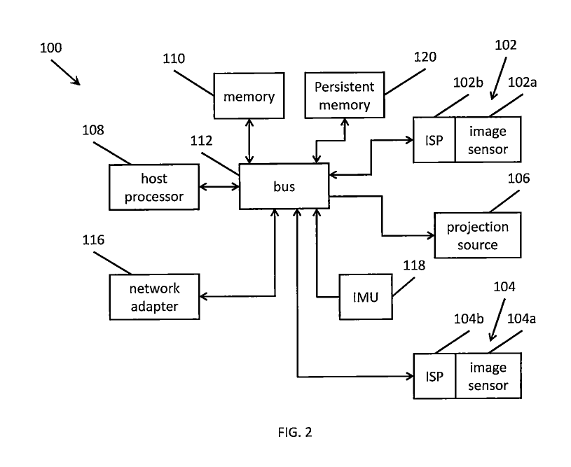

FIG. 2 is a block diagram of a stereo depth camera system according to one embodiment of the present invention. The depth camera system 100 shown in FIG. 2 includes a first camera 102, a second camera 104, a projection source 106 (or illumination source or active projection system), and a host processor 108 and memory 110, wherein the host processor may be, for example, a graphics processing unit (GPU), a more general purpose processor (CPU), an appropriately configured field programmable gate array (FPGA), or an application specific integrated circuit (ASIC). The first camera 102 and the second camera 104 may be rigidly attached, e.g., on a frame, such that their relative positions and orientations are substantially fixed. The first camera 102 and the second camera 104 may be referred to together as a “depth camera.” The first camera 102 and the second camera 104 include corresponding image sensors 102a and 104a, and may also include corresponding image signal processors (ISP) 102b and 104b. The various components may communicate with one another over a system bus 112. The depth camera system 100 may include additional components such as a network adapter 116 to communicate with other devices, an inertial measurement unit (IMU) 118 such as a gyroscope to detect acceleration of the depth camera 100 (e.g., detecting the direction of gravity to determine orientation), and persistent memory 120 such as NAND flash memory for storing data collected and processed by the depth camera system 100. The IMU 118 may be of the type commonly found in many modern smartphones. The image capture system may also include other communication components, such as a universal serial bus (USB) interface controller.

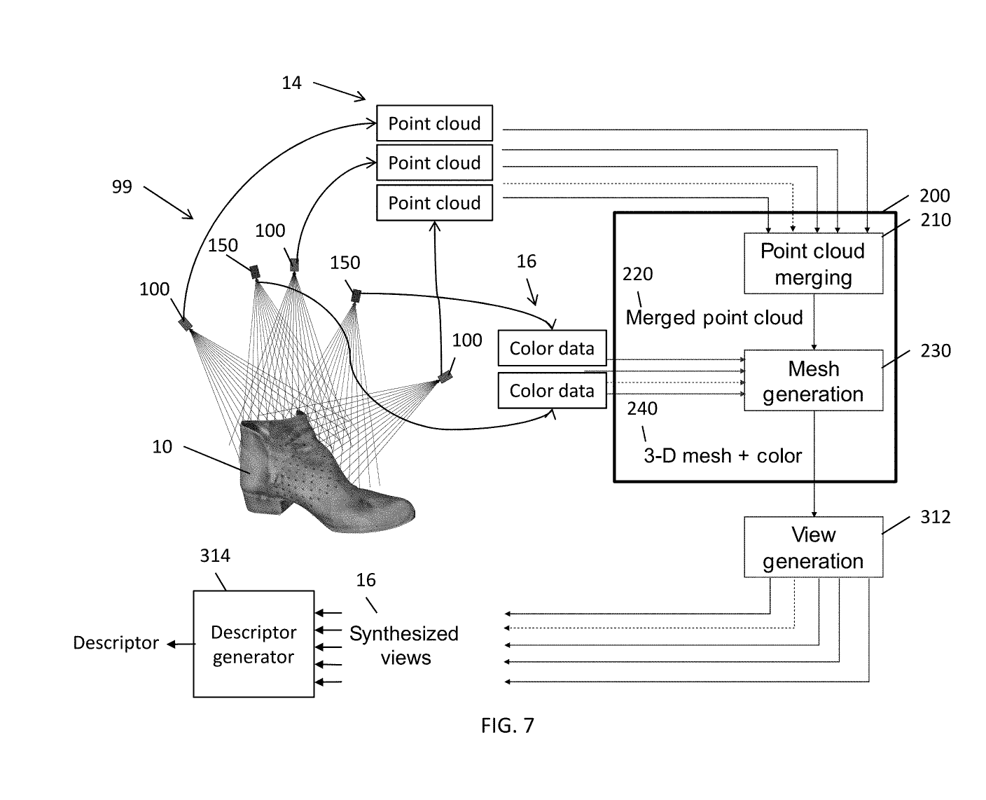

Although the block diagram shown in FIG. 2 depicts a depth camera 100 as including two cameras 102 and 104 coupled to a host processor 108, memory 110, network adapter 116, IMU 118, and persistent memory 120, embodiments of the present invention are not limited thereto. For example, the three depth cameras 100 shown in FIG. 6 (described in more detail below) may each merely include cameras 102 and 104, projection source 106, and a communication component (e.g., a USB connection or a network adapter 116), and processing the two-dimensional images captured by the cameras 102 and 104 of the three depth cameras 100 may be performed by a shared processor or shared collection of processors in communication with the depth cameras 100 using their respective communication components or network adapters 116.

In some embodiments, the image sensors 102a and 104a of the cameras 102 and 104 are RGB-IR image sensors. Image sensors that are capable of detecting visible light (e.g., red-green-blue, or RGB) and invisible light (e.g., infrared or IR) information may be, for example, charged coupled device (CCD) or complementary metal oxide semiconductor (CMOS) sensors. Generally, a conventional RGB camera sensor includes pixels arranged in a “Bayer layout” or “RGBG layout,” which is 50% green, 25% red, and 25% blue. Band pass filters (or “micro filters”) are placed in front of individual photodiodes (e.g., between the photodiode and the optics associated with the camera) for each of the green, red, and blue wavelengths in accordance with the Bayer layout. Generally, a conventional RGB camera sensor also includes an infrared (IR) filter or IR cut-off filter (formed, e.g., as part of the lens or as a coating on the entire image sensor chip) which further blocks signals in an IR portion of electromagnetic spectrum.

An RGB-IR sensor is substantially similar to a conventional RGB sensor, but may include different color filters. For example, in an RGB-IR sensor, one of the green filters in every group of four photodiodes is replaced with an IR band-pass filter (or micro filter) to create a layout that is 25% green, 25% red, 25% blue, and 25% infrared, where the infrared pixels are intermingled among the visible light pixels. In addition, the IR cut-off filter may be omitted from the RGB-IR sensor, the IR cut-off filter may be located only over the pixels that detect red, green, and blue light, or the IR filter can be designed to pass visible light as well as light in a particular wavelength interval (e.g., 840-860 nm). An image sensor capable of capturing light in multiple portions or bands or spectral bands of the electromagnetic spectrum (e.g., red, blue, green, and infrared light) will be referred to herein as a “multi-channel” image sensor.

In some embodiments of the present invention, the image sensors 102a and 104a are conventional visible light sensors. In some embodiments of the present invention, the system includes one or more visible light cameras (e.g., RGB cameras) and, separately, one or more invisible light cameras (e.g., infrared cameras, where an IR band-pass filter is located across all over the pixels). In other embodiments of the present invention, the image sensors 102a and 104a are infrared (IR) light sensors.

In some embodiments in which the depth cameras 100 include color image sensors (e.g., RGB sensors or RGB-IR sensors), the color image data collected by the depth cameras 100 may supplement the color image data captured by the color cameras 150. In addition, in some embodiments in which the depth cameras 100 include color image sensors (e.g., RGB sensors or RGB-IR sensors), the color cameras 150 may be omitted from the system.

Generally speaking, a stereoscopic depth camera system includes at least two cameras that are spaced apart from each other and rigidly mounted to a shared structure such as a rigid frame. The cameras are oriented in substantially the same direction (e.g., the optical axes of the cameras may be substantially parallel) and have overlapping fields of view. These individual cameras can be implemented using, for example, a complementary metal oxide semiconductor (CMOS) or a charge coupled device (CCD) image sensor with an optical system (e.g., including one or more lenses) configured to direct or focus light onto the image sensor. The optical system can determine the field of view of the camera, e.g., based on whether the optical system is implements a “wide angle” lens, a “telephoto” lens, or something in between.

In the following discussion, the image acquisition system of the depth camera system may be referred to as having at least two cameras, which may be referred to as a “master” camera and one or more “slave” cameras. Generally speaking, the estimated depth or disparity maps computed from the point of view of the master camera, but any of the cameras may be used as the master camera. As used herein, terms such as master/slave, left/right, above/below, first/second, and CAM1/CAM2 are used interchangeably unless noted. In other words, any one of the cameras may be master or a slave camera, and considerations for a camera on a left side with respect to a camera on its right may also apply, by symmetry, in the other direction. In addition, while the considerations presented below may be valid for various numbers of cameras, for the sake of convenience, they will generally be described in the context of a system that includes two cameras. For example, a depth camera system may include three cameras. In such systems, two of the cameras may be invisible light (infrared) cameras and the third camera may be a visible light (e.g., a red/blue/green color camera) camera. All three cameras may be optically registered (e.g., calibrated) with respect to one another. One example of a depth camera system including three cameras is described in U.S. patent application Ser. No. 15/147,879 “Depth Perceptive Trinocular Camera System” filed in the United States Patent and Trademark Office on May 5, 2016, the entire disclosure of which is incorporated by reference herein.

To detect the depth of a feature in a scene imaged by the cameras, the depth camera system determines the pixel location of the feature in each of the images captured by the cameras. The distance between the features in the two images is referred to as the disparity, which is inversely related to the distance or depth of the object. (This is the effect when comparing how much an object “shifts” when viewing the object with one eye at a time—the size of the shift depends on how far the object is from the viewer's eyes, where closer objects make a larger shift and farther objects make a smaller shift and objects in the distance may have little to no detectable shift.) Techniques for computing depth using disparity are described, for example, in R. Szeliski. “Computer Vision: Algorithms and Applications”, Springer, 2010 pp. 467 et seq.

The magnitude of the disparity between the master and slave cameras depends on physical characteristics of the depth camera system, such as the pixel resolution of cameras, distance between the cameras and the fields of view of the cameras. Therefore, to generate accurate depth measurements, the depth camera system (or depth perceptive depth camera system) is calibrated based on these physical characteristics.

In some depth camera systems, the cameras may be arranged such that horizontal rows of the pixels of the image sensors of the cameras are substantially parallel. Image rectification techniques can be used to accommodate distortions to the images due to the shapes of the lenses of the cameras and variations of the orientations of the cameras.

In more detail, camera calibration information can provide information to rectify input images so that epipolar lines of the equivalent camera system are aligned with the scanlines of the rectified image. In such a case, a 3-D point in the scene projects onto the same scanline index in the master and in the slave image. Let uₘ and uₛ be the coordinates on the scanline of the image of the same 3-D point p in the master and slave equivalent cameras, respectively, where in each camera these coordinates refer to an axis system centered at the principal point (the intersection of the optical axis with the focal plane) and with horizontal axis parallel to the scanlines of the rectified image. The difference uₛ-uₘ is called disparity and denoted by d; it is inversely proportional to the orthogonal distance of the 3-D point with respect to the rectified cameras (that is, the length of the orthogonal projection of the point onto the optical axis of either camera).

Stereoscopic algorithms exploit this property of the disparity. These algorithms achieve 3-D reconstruction by matching points (or features) detected in the left and right views, which is equivalent to estimating disparities. Block matching (BM) is a commonly used stereoscopic algorithm. Given a pixel in the master camera image, the algorithm computes the costs to match this pixel to any other pixel in the slave camera image. This cost function is defined as the dissimilarity between the image content within a small window surrounding the pixel in the master image and the pixel in the slave image. The optimal disparity at point is finally estimated as the argument of the minimum matching cost. This procedure is commonly addressed as Winner-Takes-All (WTA). These techniques are described in more detail, for example, in R. Szeliski. “Computer Vision: Algorithms and Applications”, Springer, 2010. Since stereo algorithms like BM rely on appearance similarity, disparity computation becomes challenging if more than one pixel in the slave image have the same local appearance, as all of these pixels may be similar to the same pixel in the master image, resulting in ambiguous disparity estimation. A typical situation in which this may occur is when visualizing a scene with constant brightness, such as a flat wall.

Methods exist that provide additional illumination by projecting a pattern that is designed to improve or optimize the performance of block matching algorithm that can capture small 3-D details such as the one described in U.S. Pat. No. 9,392,262 “System and Method for 3-D Reconstruction Using Multiple Multi-Channel Cameras,” issued on Jul. 12, 2016, the entire disclosure of which is incorporated herein by reference. Another approach projects a pattern that is purely used to provide a texture to the scene and particularly improve the depth estimation of texture-less regions by disambiguating portions of the scene that would otherwise appear the same.

The projection source 106 according to embodiments of the present invention may be configured to emit visible light (e.g., light within the spectrum visible to humans and/or other animals) or invisible light (e.g., infrared light) toward the scene imaged by the cameras 102 and 104. In other words, the projection source may have an optical axis substantially parallel to the optical axes of the cameras 102 and 104 and may be configured to emit light in the direction of the fields of view of the cameras 102 and 104. In some embodiments, the projection source 106 may include multiple separate illuminators, each having an optical axis spaced apart from the optical axis (or axes) of the other illuminator (or illuminators), and spaced apart from the optical axes of the cameras 102 and 104.

An invisible light projection source may be better suited to for situations where the subjects are people (such as in a videoconferencing system) because invisible light would not interfere with the subject's ability to see, whereas a visible light projection source may shine uncomfortably into the subject's eyes or may undesirably affect the experience by adding patterns to the scene. Examples of systems that include invisible light projection sources are described, for example, in U.S. patent application Ser. No. 14/788,078 “Systems and Methods for Multi-Channel Imaging Based on Multiple Exposure Settings,” filed in the United States Patent and Trademark Office on Jun. 30, 2015, the entire disclosure of which is herein incorporated by reference.

Active projection sources can also be classified as projecting static patterns, e.g., patterns that do not change over time, and dynamic patterns, e.g., patterns that do change over time. In both cases, one aspect of the pattern is the illumination level of the projected pattern. This may be relevant because it can influence the depth dynamic range of the depth camera system. For example, if the optical illumination is at a high level, then depth measurements can be made of distant objects (e.g., to overcome the diminishing of the optical illumination over the distance to the object, by a factor proportional to the inverse square of the distance) and under bright ambient light conditions. However, a high optical illumination level may cause saturation of parts of the scene that are close-up. On the other hand, a low optical illumination level can allow the measurement of close objects, but not distant objects.

Although embodiments of the present invention are described herein with respect to stereo depth camera systems, embodiments of the present invention are not limited thereto and may also be used with other depth camera systems such as structured light time of flight cameras and LIDAR cameras.

Depending on the choice of camera, different techniques may be used to generate the 3-D model. For example, Dense Tracking and Mapping in Real Time (DTAM) uses color cues for scanning and Simultaneous Localization and Mapping (SLAM) uses depth data (or a combination of depth and color data) to generate the 3-D model.

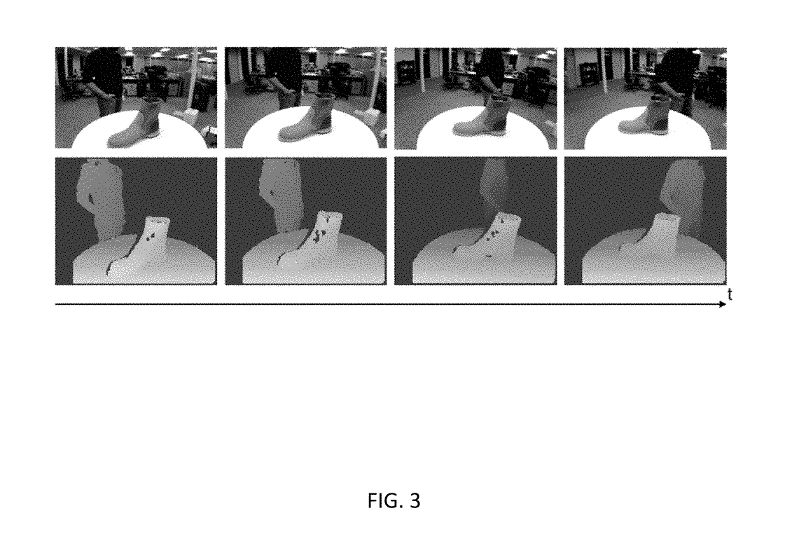

FIG. 3 is an example of a sequence of frames including depth maps and color images acquired by a depth camera that includes active stereo and at least one color camera. As shown in FIG. 3, the upper row shows four color images of a boot on a table, while the lower row shows the depth maps corresponding to (e.g., captured contemporaneously or concurrently or substantially simultaneously with) the color images. As shown in the bottom row, portions of the scene that are closer to the depth camera are shown in yellow and portions of the scene that are farther away are shown in blue. Accordingly, the boot and the table are shown generally in yellow, while the background, including a person standing in the background, are shown in shades of blue. The object of interest can be separated from the background by removing pixels that have a depth greater than a threshold (e.g., removing the blue pixels in the images shown in the bottom row of FIG. 3) and by also removing the planar surface at the bottom of the remaining model.

The depth images captured at the various angles (e.g., the different columns of FIG. 3) can be combined to generate a 3-D model of the object through techniques such as iterative closest point (ICP) and structure from motion (SfM). The 3-D models may be represented as a point cloud (e.g., a collection of three-dimensional points having x, y, and z coordinates) and/or as a mesh (e.g., a collection of triangles).

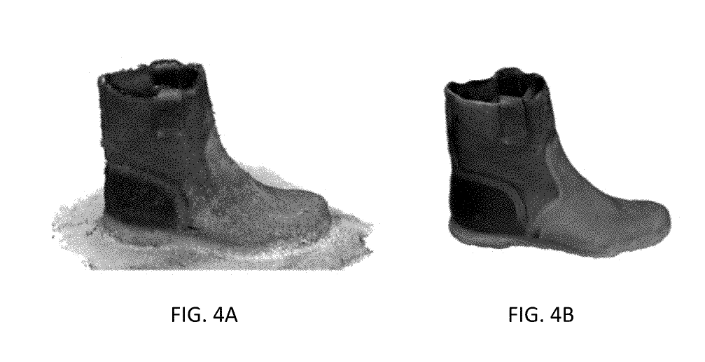

FIG. 4A is a 2-D view of an example of a 3-D point cloud model, and FIG. 4B is a 2-D view of an example of a 3-D mesh model captured using one or more depth cameras. Examples of systems and methods for scanning are described in, for example, U.S. patent application Ser. No. 15/382,210, “3D SCANNING APPARATUS INCLUDING SCANNING SENSOR DETACHABLE FROM SCREEN,” filed in the United States Patent and Trademark Office on Dec. 16, 2016; U.S. patent application Ser. No. 15/445,735, “ASSISTED SCANNING,” filed in the United States Patent and Trademark Office on Feb. 28, 2017; and U.S. patent application Ser. No. 15/630,715, “SYSTEM AND METHODS FOR A COMPLETE 3D OBJECT SCAN,” filed in the United States Patent and Trademark Office on Jun. 22, 2017; the entire disclosures of which are incorporated by reference herein.

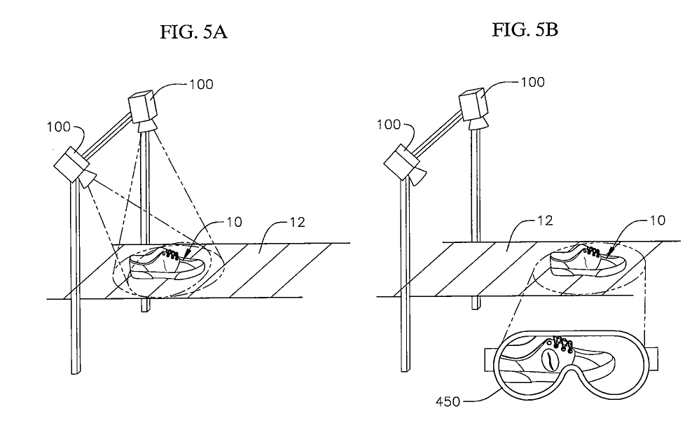

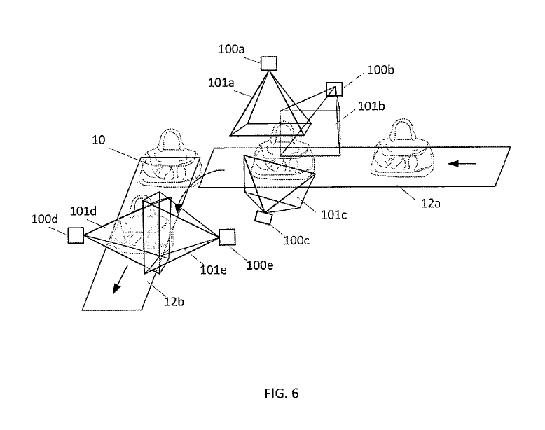

To capture a full 3-D model of an object (e.g., of substantially all non-occluded surfaces of the object), it is necessary to acquire frames from an ensemble of different vantage points, such that all the locations on the surface of the object being scanned are framed from at least one of such frames. In some circumstances, it may be impractical to capture images of the bottom surface of the object (e.g., the surface of the object resting on a support such as a conveyor belt) and therefore, without limitation thereto, the term “full 3-D model” will be assumed to include circumstances where the bottom surface of the object is not captured. Capturing such information from an ensemble of viewpoints is generally a bottleneck of 3-D modeling systems, especially in the case of objects moving on a conveyor belt on a manufacturing line. Gathering such a large amount of data from a single scanner it would generally require a relatively long amount of time and the exploitation of moving components that are able to move the scanner to account for the motion of the conveyor belt. Accordingly, some embodiments of the present invention relate to aggregating data coming from multiple depth cameras (or multiple 3-D scanners), as shown in FIGS. 5 and 6.

FIG. 5A is a schematic diagram of a scanning system 99 configured to scan objects on a conveyor belt according to one embodiment of the present invention. FIG. 5B is a schematic diagram of an inspection system configured to display inspection data of objects on a conveyor belt according to one embodiment of the present invention. FIG. 6 is a schematic depiction of an object (depicted as a handbag) traveling on a conveyor belt having two portions, where the first portion moves the object along a first direction and the second portion moves the object along a second direction that is orthogonal to the first direction in accordance with one embodiment of the present invention.

As shown in FIGS. 5A, 5B, and 6, a scanning system 99 may include multiple depth cameras 100. Each of the depth cameras 100 is calibrated at manufacturing, obtaining an estimate of the intrinsic parameters of its (2-D) camera sensors and an estimate of the intra-scanner extrinsic parameters (e.g. the rotation and translation between all the sensors, such as image sensors 102a and 104a of FIG. 2, of a single depth camera 100). An overview of standard multi-camera calibration procedures can be found in Zanuttigh, P., et al., Time-of-Flight and Structured Light Depth Cameras. 2016, Springer. After scanning, a display 450 of a display device system 400 may be used to visualize defects and other information detected regarding the object 10. As shown in FIG. 5A, the object 10 (a shoe) includes creases in vamp section and a crease in the quarter (e.g., side) of the shoe, where the creases in the vamp section are expected and within specification (e.g., not defective), but the crease in the quarter of the shoe is not expected (e.g., is outside of the specification and is a defect). As shown in FIG. 5B, in the view of the object 10 through the display 450, the crease on the quarter of the shoe is highlighted (e.g., circled in FIG. 5B) to emphasize the detection of a defect, but the creases on the vamp of the shoe are not highlighted in the view because they are expected to be there (e.g., not defects).

As one example of an arrangement of cameras, FIG. 6 is a schematic depiction of an object 10 (depicted as a handbag) traveling on a conveyor belt 12 having two portions, where the first portion moves the object 10 along a first direction and the second portion moves the object 10 along a second direction that is orthogonal to the first direction in accordance with one embodiment of the present invention. When the object 10 travels along the first portion 12a of the conveyor belt 12, a first camera 100a images the top surface of the object 10 from above, while second and third cameras 100b and 100c image the sides of the object 10. In this arrangement, it may be difficult to image the ends of the object 10 because doing so would require placing the cameras along the direction of movement of the conveyor belt and therefore may obstruct the movement of the objects 10. As such, the object 10 may transition to the second portion 12b of the conveyor belt 12, where, after the transition, the end of the object 10 are now visible to cameras 100d and 100e located on the sides of the second portion 12b of the conveyor belt 12. As such, FIG. 6 illustrates an example of an arrangement of cameras that allows coverage of the entire visible surface of the object 10.

In some embodiments, the extrinsic parameters of the depth cameras 100 (e.g., relative poses) are estimated through another calibration step, in which a calibration target (e.g., an object of known size with identifiable and precisely detectable features, such as a black-and-white 2-D checkerboard) is acquired by all the depth cameras, in order to detect the relative rotation and translation between each of the scanner composing the 3-D modeling system. Accordingly, the extrinsic parameters can be used to compute or to estimate the transformations that may be applied to the separate depth maps (e.g., 3-D point clouds) captured by the different depth cameras in order to merge the depth maps to generate the captured 3-D model of the object.

Examples of systems and methods for three-dimensional scanning are described in more detail in U.S. patent application Ser. No. 15/866,217, “SYSTEMS AND METHODS FOR DEFECT DETECTION,” filed in the United States Patent and Trademark Office on Jan. 9, 2018 and U.S. patent application Ser. No. 15/974,595, “SYSTEMS AND METHODS FOR INSPECTION AND DEFECT DETECTION USING 3-D SCANNING,” filed in the United States Patent and Trademark Office on May 8, 2018, the entire disclosures of which are incorporated by reference herein.

Generation of 3-D Models

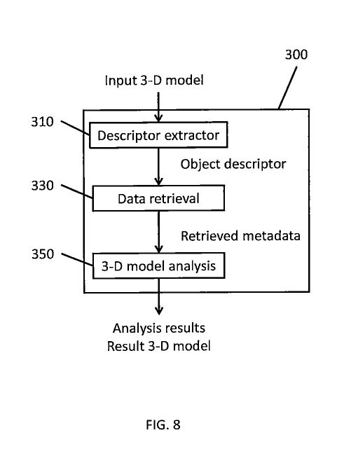

If depth images are captured by the depth cameras 100 at different poses (e.g., different locations with respect to the target object 10), then it is possible to acquire data regarding the shape of a larger portion of the surface of the target object 10 than could be acquired by a single depth camera through a point cloud merging module 210 (see FIG. 7) of a 3-D model generation module 200 that merges the separate depth images (represented as point clouds) 14 into a merged point cloud 220. For example, opposite surfaces of an object (e.g., the medial and lateral sides of the boot shown in FIG. 7) can both be acquired, whereas a single camera at a single pose could only acquire a depth image of one side of the target object at a time. The multiple depth images can be captured by moving a single depth camera over multiple different poses or by using multiple depth cameras located at different positions. Merging the depth images (or point clouds) requires additional computation and can be achieved using techniques such as an Iterative Closest Point (ICP) technique (see, e.g., Besl, Paul J., and Neil D. McKay. “Method for registration of 3-D shapes.” Robotics-DL tentative. International Society for Optics and Photonics, 1992.), which can automatically compute the relative poses of the depth cameras by optimizing (e.g., minimizing) a particular alignment metric. The ICP process can be accelerated by providing approximate initial relative poses of the cameras, which may be available if the cameras are “registered” (e.g., if the poses of the cameras are already known and substantially fixed in that their poses do not change between a calibration step and runtime operation). Systems and methods for capturing substantially all visible surfaces of an object are described, for example, in U.S. patent application Ser. No. 15/866,217, “Systems and Methods for Defect Detection,” filed in the United States Patent and Trademark Office on Jan. 9, 2018, the entire disclosure of which is incorporated by reference herein.

A point cloud, which may be obtained by merging multiple aligned individual point clouds (individual depth images) can be processed to remove “outlier” points due to erroneous measurements (e.g., measurement noise) or to remove structures that are not of interest, such as surfaces corresponding to background objects (e.g., by removing points having a depth greater than a particular threshold depth) and the surface (or “ground plane”) that the object is resting upon (e.g., by detecting a bottommost plane of points).

In some embodiments, the system further includes a plurality of color cameras 150 configured to capture texture (color) data 16 of the query object. As noted above, in some embodiments of the present invention, the depth cameras may use RBG-IR sensors which capture both infrared data and color camera data, such that the depth cameras 100 provide color data 166 instead of using separate color cameras 150. The texture data may include the color, shading, and patterns on the surface of the object that are not present or evident in the physical shape of the object. In some circumstances, the materials of the target object may be reflective (e.g., glossy). As a result, texture information may be lost due to the presence of glare and the captured color information may include artifacts, such as the reflection of light sources within the scene. As such, some aspects of embodiments of the present invention are directed to the removal of glare in order to capture the actual color data of the surfaces. In some embodiments, this is achieved by imaging the same portion (or “patch”) of the surface of the target object from multiple poses, where the glare may only be visible from a small fraction of those poses. As a result, the actual color of the patch can be determined by computing a color vector associated with the patch for each of the color cameras, and computing a color vector having minimum magnitude from among the color vectors. This technique is described in more detail in U.S. patent application Ser. No. 15/679,075, “System and Method for Three-Dimensional Scanning and for Capturing a Bidirectional Reflectance Distribution Function,” filed in the United States Patent and Trademark Office on Aug. 15, 2017, the entire disclosure of which is incorporated by reference herein.

In some embodiments, the point clouds are combined to generate a 3-D model. FIG. 7 is a schematic block diagram illustrating a process for capturing images of a target object and detecting defects in the target object according to one embodiment of the present invention. For example, the separate point clouds 14 are merged by a point cloud merging module 210 to generate a merged point cloud 220 (e.g., by using ICP to align and merge the point clouds and also by removing extraneous or spurious points to reduce noise and to manage the size of the point cloud 3-D model). In some embodiments, a mesh generation module 230 computes a 3-D mesh 240 from the merged point cloud using techniques such as Delaunay triangulation and alpha shapes and software tools such as MeshLab (see, e.g., P. Cignoni, M. Callieri, M. Corsini, M. Dellepiane, F. Ganovelli, G. Ranzuglia MeshLab: an Open-Source Mesh Processing Tool Sixth Eurographics Italian Chapter Conference, pages 129-136, 2008.). The 3-D model (whether a 3-D point cloud model 220 or a 3-D mesh model 240) can be combined with color information 16 from the color cameras 150 about the color of the surface of the object at various points, and this color information may be applied to the 3-D point cloud or 3-D mesh model as a texture map (e.g., information about the color of the surface of the model).

Inspection Agent

Referring back to the block diagram of FIG. 1B, in some embodiments of the present invention, the 3-D model acquired by the one or more 3-D scanners can be supplied to an inspection agent or inspection system 300, which analyzes the input data (e.g., the 3-D model and, in some instances, a subset of the acquired frames) in operation 1300, in order to infer properties about the object itself.

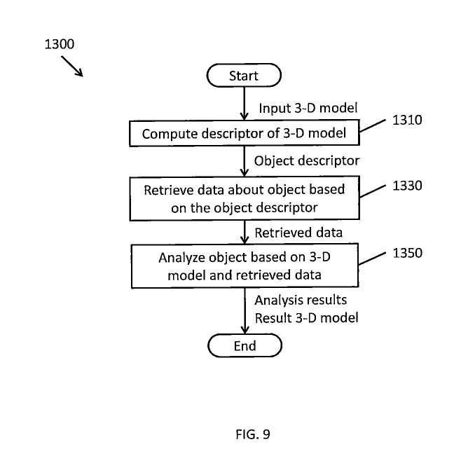

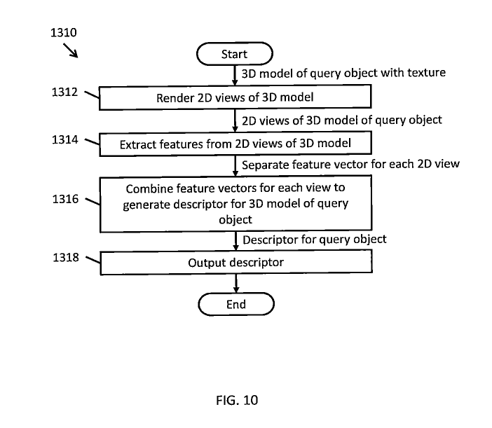

FIG. 8 is a block diagram of an inspection system according to one embodiment of the present invention. FIG. 9 is a flowchart of a method for analyzing a 3-D model of an object using an inspection system according to one embodiment of the present invention. The inspection agent 300 may be implemented using a computer system, which may include a processor and memory, where the memory stores instructions that cause the processor to execute various portions of methods according to embodiments of the present invention. As shown in FIG. 8, the inspection system 300 may include a descriptor extractor module 310, a data retrieval module 330 and a 3-D model analysis module 350. In operation 1310, the descriptor extractor module 310 generates an object descriptor from an input 3-D module, and the data retrieval module 330 retrieves, in operation 1330, metadata (e.g., from a database) corresponding to the object based on the object descriptor. The 3-D model analysis module 350 uses the retrieved data to analyze the input 3-D model in operation 1350 and to generate analysis results, which may include one or more result 3-D models. (In some embodiments of the present invention, operations 1310 and 1330 are omitted, such as in circumstances where the classes of the objects presented to the inspection system are already known. These may include circumstances where a change in the type of object being presented is manually specified by a user such as a human inspector or automatically specified by other equipment in the system such as a work scheduler or ticketing system.)

Various computational portions of embodiments of the present invention may be implemented through purpose-specific computer instructions executed by a computer system. The computer system may include one or more processors, including one or more central processing units (CPUs), one or more graphics processing units (GPUs), one or more field programmable gate arrays (FPGAs), one or more digital signal processors (DSPs), and/or one or more application specific integrated circuits (ASICs) such as neuromorphic processors and tensor processing units (TPUs). The computer system may also include peripherals such as communications devices (e.g., network adapters, serial or parallel data bus adapters, graphics adapters) for transmitting and/or receiving data to and from other devices such as 3-D scanning systems, data storage systems (e.g., databases), display devices, and other computer systems. The computations may be distributed across multiple separate computer systems, some of which may be local to the scanning of the query objects (e.g., on-site and connected directly to the depth and color cameras, or connected to the depth and color cameras over a local area network), and some of which may be remote (e.g., off-site, “cloud” based computing resources connected to the depth and color cameras through a wide area network such as the Internet). For the sake of convenience, the computer systems configured using particular computer instructions to perform purpose specific operations for inspecting target objects based on captured images of the target objects are referred to herein as parts of inspection agents or inspection systems.

Object Identification

According to some embodiments of the present invention, the inspection agent 300 identifies an object based on its 3-D model. In various embodiments of the present invention, identification of the object is used to obtain a set of identity-specific measurements. For example, a running shoe may be evaluated based on different criteria than a hiking boot because the two types of footwear may have different shapes, colors, sizes, and quality requirements.

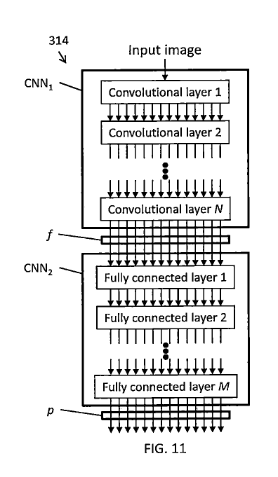

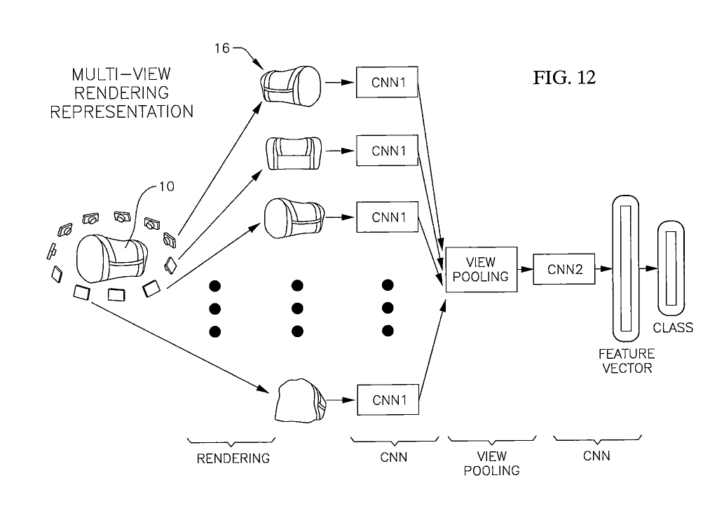

Referring to FIG. 9, in operation 1310, the inspection system 300 computes a descriptor of the 3-D model. FIG. 10 is a flowchart of a method for computing a descriptor of a query object from a 3-D model of the query object according to one embodiment of the present invention. FIG. 11 is a block diagram of a convolutional neural network based classification system according to one embodiment of the present invention.

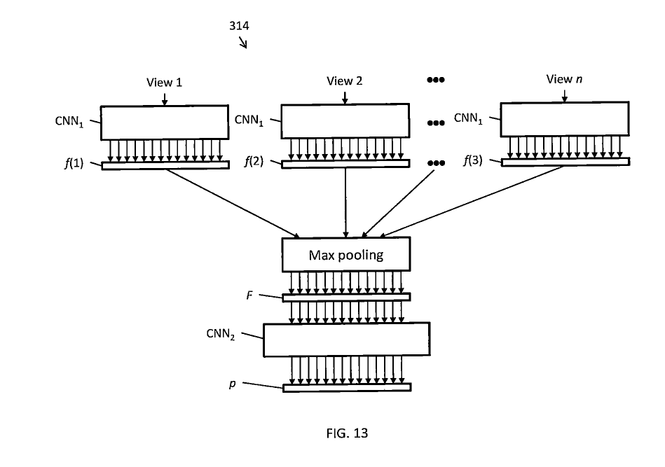

In some embodiments of the present invention, the object identification is performed by computing a descriptor of the 3-D model of the object, where the descriptor is a multi-dimensional vector (e.g., having a dimensionality of 16 or 4096). Common techniques for computing a descriptor of a 3-D model are based on a forward evaluation of a Multi-View Convolutional Neural Network (MV-CNN) or by a Volumetric Convolutional Neural Network (V-CNN). Such networks are usually trained for object classification, and, in some embodiments, the output of the penultimate layer of the network is used as the descriptor, as shown in FIG. 12 (described in more detail below).

In particular, in the embodiment shown in FIG. 7, the descriptor is computed from 2-D views 16 of the 3-D model 240, as rendered by the view generation module 312 in operation 1312. In operation 1314, the synthesized 2-D views are supplied to a descriptor generator 314 to extract a descriptor or feature vector for each view. In operation 1316, the feature vectors for each view are combined (e.g., using max pooling, as described in more detail below) to generate a descriptor for the 3-D model and to classify the object based on the descriptor. This feature vector may contain salient and characteristic aspects of the object's shape, and is used for subsequent classification or retrieval steps. The generated descriptor may be output in operation 1318.

Generally, the task of classifying a shape s into one of a set C of given classes (also called categories or labels) is distinguished from the task of retrieving from a database the shape that is most similar (under a specific metric) to a given shape. For the sake of convenience herein, shape retrieval will be considered as a special case of classification, in which each shape in the database represents a class in itself, and a shape s is classified with the label of the most similar shape in the database. This approach is sometimes referred to as nearest neighbor classification in the pattern recognition literature.

Several techniques for retrieval and classification from view-based representations of shapes are known in the literature. See, for example, Gao, Y., & Dai, Q. (2014). View-based 3-D object retrieval: challenges and approaches. IEEE MultiMedia, 3(21), 52-57. for a survey of such relevant techniques. For example, one approach (described in Furuya, T., & Ohbuchi, R. (2009, July). Dense sampling and fast encoding for 3-D model retrieval using bag-of-visual features. In Proceedings of the ACM international conference on image and video retrieval (p. 26). ACM.) [00132] expands on the concept of “bags of words,” a classic method for object recognition in images, to the case of multi-view object recognition. As another example, convolutional neural networks (CNNs) may be used for multi-view object classification (see, e.g., Su, H., Maji, S., Kalogerakis, E., & Learned-Miller, E. (2015). Multi-view convolutional neural networks for 3-D shape recognition. In Proceedings of the IEEE International Conference on Computer Vision (pp. 945-953).).

According to some embodiments of the present invention, a convolutional neural network (CNN) is used to process the synthesized 2-D views to generate the classification of the object. FIG. 11 is a schematic diagram of a descriptor generator 314 according to one embodiment of the present invention implemented as a deep convolutional neural network (CNN). Generally, a deep CNN processes an image by passing the input image data (e.g., a synthesized 2-D view) through a cascade of layers. These layers can be grouped into multiple stages. The deep convolutional neural network shown in FIG. 11 includes two stages, a first stage CNN₁ made up of N layers (or sub-processes) and a second stage CNN₂ made up of M layers. In one embodiment, each of the N layers of the first stage CNN₁ includes a bank of linear convolution layers, followed by a point non-linearity layer and a non-linear data reduction layer. In contrast, each of the M layers of the second stage CNN₂ is a fully connected layer. The output p of the second stage is a class-assignment probability distribution. For example, if the entire CNN is trained to assign input images to one of k different classes, then the output of the second stage CNN₂ is a vector p that includes k different values, each value representing the probability (or “confidence”) that the input image should be assigned the corresponding class.

As noted above, embodiments of the present invention may be implemented on suitable general purpose computing platforms, such as general purpose computer processors and application specific computer processors. For example, graphical processing units (GPUs) and other vector processors (e.g., single instruction multiple data or SIMD instruction sets of general purpose processors) are often well suited to performing the training and operation of neural networks.

In some embodiments, the neural network is trained based on training data, which may include a set of 3-D models of objects and their corresponding labels (e.g., the correct classifications of the objects). A portion of this training data may be reserved as cross-validation data to further adjust the parameters of during the training process, and a portion may also be reserved as a test data to confirm that the network is properly trained.

The parameters of the neural network (e.g., the weights of the connections between the layers) can be used using standard processes for training neural network such as backpropagation and gradient descent (see, e.g., LeCun, Y., & Bengio, Y. (1995). Convolutional networks for images, speech, and time series. The handbook of brain theory and neural networks, 3361(10), 1995.). In addition, the training process may be initialized using parameters from a pre-trained general-purpose image classification neural network (see, e.g., Chatfield, K., Simonyan, K., Vedaldi, A., & Zisserman, A. (2014). Return of the devil in the details: Delving deep into convolutional nets. arXiv preprint arXiv:1405.3531.).

As shown in FIG. 11, the values computed by the first stage CNN₁ (the convolutional stage) and supplied to the second stage CNN₂ (the fully connected stage) are referred to herein as a descriptor (or feature vector) f. The feature vector or descriptor may be a vector of data having a fixed size (e.g., 4,096 entries) which condenses or summarizes the main characteristics of the input image. As such, the first stage CNN₁ may be referred to as a feature extraction stage of the classification system 270.

The architecture of a classifier 270 described above with respect to FIG. 11 can be applied to classifying multi-view shape representations of 3-D objects based on n different 2-D views of the object. For example, the first stage CNN₁ can be applied independently to each of the n 2-D views used to represent the 3-D shape, thereby computing a set of n feature vectors (one for each of the 2-D views). Aspects of this technique are described in more detail in, for example, Su, H., Maji, S., Kalogerakis, E., & Learned-Miller, E. (2015). Multi-view convolutional neural networks for 3-D shape recognition. In Proceedings of the IEEE International Conference on Computer Vision (pp. 945-953). In some embodiments, the n separate feature vectors are combined using, for example, max pooling (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).).

FIGS. 12 and 13 are illustration of max-pooling according to one embodiment of the present invention. As shown in FIG. 13, each of the n views is supplied to the first stage CNN₁ of the descriptor generator 314 to generate n feature vectors. In max-pooling, the n feature vectors fare combined to generate a single combined feature vector or descriptor F, where the j-th entry of the descriptor F is equal to the maximum among the j-th entries among the n feature vectors f. The resulting descriptor F has the same length (or rank) as the n feature vectors f and therefore descriptor F can also be supplied as input to the second stage CNN₂ to compute a classification of the object.

In some embodiments of the present invention, the selection of particular poses of the virtual cameras, e.g., the selection of which particular 2-D views to render, results in a descriptor F having properties that are substantially invariant. For example, considering a configuration where all the virtual cameras are located on a sphere (e.g., all arranged at poses that are at the same distance from the center of the 3-D model or a particular point p on the ground plane, and all having optical axes that intersect at the center of the 3-D model or at the particular point p on the ground plane). Another example of an arrangement with similar properties includes all of the virtual cameras located at the same elevation above the ground plane of the 3-D model, oriented toward the 3-D model (e.g., having optical axes intersecting with the center of the 3-D model), and at the same distance from the 3-D model, in which case any rotation of the object around a vertical axis (e.g., perpendicular to the ground plane) extending through the center of the 3-D model will result in essentially the same vector or descriptor F (assuming that the cameras are placed at closely spaced locations).

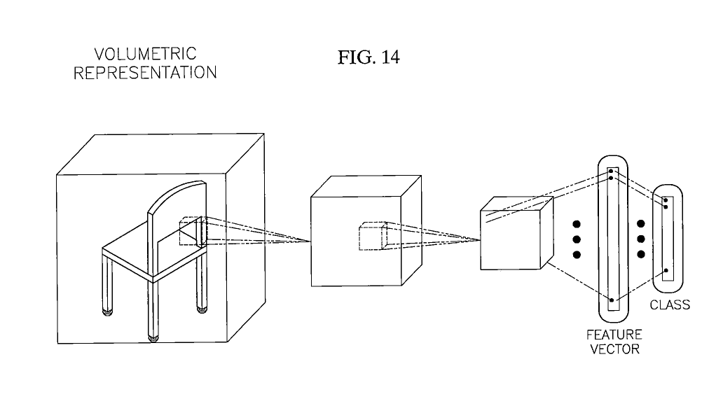

Some embodiments of the present invention may also use a voxelization approach to generate a feature vector from a volumetric representation of the 3-D model. FIG. 14 is a schematic diagram illustrating the analysis of a volumetric representation of a feature vector according to one embodiment of the present invention, where a convolutional neural network is supplied with feature vectors that correspond to volumes that intersect with the surface of the 3-D model, where the volumes have a size and shape corresponding to a volumetric 3-D convolutional kernel (rather than 2-D patches of the 2-D view corresponding to the size of the 2-D convolutional kernel).

The extracted feature vector can then be supplied to a classifier to classify the object as being a member of one of a particular set of k different classes C, thereby resulting in classification of the query object 10. This can be done, for example, by supplying the descriptor F to the second stage CNN₂, resulting in the vector p of normalized positive numbers representing the class-assignment probability distribution. The index of the largest entry of this vector p is the most likely class for the given shape, with the associated maximum value representing the confidence of this classification. As such, the second stage CNN₂ may be referred to as a classification stage of the convolutional neural network.

In some embodiments of the present invention, the descriptor vector is used to query a database of objects for which are associated with descriptors that were previously computed using the same technique. This database of objects constitutes a set of known objects, and a known object corresponding to the current object (e.g., the scanned object or “query object”) can be identified by searching for the closest (e.g. most similar) descriptor in the multi-dimensional space of descriptors, with respect to the descriptor of the current object.

In more detail, in some embodiments of the present invention, the classifier CNN₂ classifies the target object 10 by using the descriptor F of the target object to retrieve a most similar shape in a data set, rather than by supplying the descriptor F to the second stage CNN₂. In more detail, all of the objects in the training set may be supplied to the first stage CNN₁ to generate a set of known descriptors {F_{ds}(m)}, where the index m indicates a particular labeled shape in the training data. A similarity metric is defined to measure the distance between any two given descriptors (vectors) F and F_{ds}(m). Some simple examples of similarity metrics are a Euclidean vector distance and a Mahalanobis vector distance. In other embodiments of the present invention a similarity metric is learned using a metric learning algorithm (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).). A metric learning algorithm may learn a linear or non-linear transformation of feature vector space that minimizes the average distance between vector pairs belonging to the same class (as measured from examples in the training data) and maximizes the average distance between vector pairs belonging to different classes.

In one embodiment of the present invention, the inspection agent 300 performs object identification using a multi-view CNN that has been pre-retrained on generic object classification, in order to obtain a “black box” that is able to provide a uniquely identifiable signature (which may also be referred to as a “feature vector”) for a given 3-D model. This feature vector is then fed into a nearest neighbor classifier that performs nearest neighbor search within a database of features vectors of possible identities to be retrieved. Optionally dimensionality reduction approaches can be considered, such as Large Margin Nearest Neighbor metric learning and Principal Components Analysis (PCA).

Some examples of systems and methods for identifying objects are described, for example, in U.S. patent application Ser. No. 15/675,684, “SYSTEMS AND METHODS FOR 3D MODELS GENERATION WITH AUTOMATIC METADATA,” filed in the United States Patent and Trademark Office on Aug. 11, 2017 and U.S. patent application Ser. No. 15/862,512, “SHAPE-BASED OBJECT RETRIEVAL AND CLASSIFICATION,” filed in the United States Patent and Trademark Office on Jan. 4, 2018 the entire disclosures of which are incorporated by reference herein. Other techniques such as dimensionality reduction, principal component analysis (PCA), metric learning and support vector machines (SVM) may also be used to improve identification results either in terms of identification performances or in terms of computational resources.

Once the query object has been classified, data about the identified class may be retrieved from, for example, a database of metadata about the objects. The retrieved class data may include, for example, the expected dimensions of objects of the given class (e.g., size, shape, color), a reference 3-D model (e.g., a 3-D model of a canonical instance of the class (e.g., the expected shape of a manufactured part)), one or more defect detection models (e.g., models, such as convolutional neural networks, trained to detect defects in the object based on the captured 3-D model) and the like.

Defect Detection

Once an object has been identified, the 3-D model analysis module 350 of the inspection agent 300 analyzes the input 3-D model (and, in some instances, its frames), in the context of the retrieved data about the identified class, in order to provide some insights and analysis about the object itself.

Generally, the properties that can be inspected fall into two categories: variables and attributes. The term “variables,” as used herein in the context of the analysis of the 3-D model, refers to measurable physical quantities, e.g., the size of the minimum bounding box containing the object itself, the volume occupied by the object, and the size of a shoe, and the like. The term “attributes,” as used herein in the context of the analysis of the 3-D model, refers to aspects that are not necessarily numeric values, such as the presence or absence of pronounced wrinkles on a leather component or the presence or absence of stains on fabric components (e.g., in excess of some threshold tolerance). In other words, a variable may be characterized by a specific numeric value, which can be uniquely measured, whereas an attribute may relate to the presence or absence of a characteristic (e.g., a binary value) in accordance with a subjective or qualitative analysis (e.g., two different people may provide different inspection results for an “attribute” or a qualitative characteristic). In some embodiments of the present invention, rather than a binary characteristic, an attribute may take on a plurality of different values, each value corresponding to a different category (e.g., classifying different types of defects in the surface of a shoe as stains, wrinkles, tears, and holes) or values in a range (e.g., the “magnitude” of a surface stain may refer to how much the stain differs from the color of the surrounding material or the magnitude of a wrinkle may refer to its depth).

The measurement of “variables” in a 3-D model can be considered a classical machine vision problem, for which ad-hoc techniques as well as learning-based techniques can be applied in various embodiments of the present invention.

On the other hand, in the case of “attributes,” some embodiments of the present invention apply a regression-based learning approaches to train models for automatically evaluating and assigning attributes to an object based on its model. In some such embodiments, a multitude of evaluations provided by subject matter experts may be used to develop a set of training data. One example of the evaluation of an attribute relates to detecting unacceptable wrinkles on leather shoes. In this case, various sets of shoes that present different types of wrinkles are presented to a set of human experts (e.g., trained inspectors for the particular manufacturing line where the inspection agent 300 will be used), and the human experts evaluate each single shoe to determine whether the wrinkling is acceptable or not. An average acceptability value can be computed based on the percentage of the experts that evaluated the degree of wrinkling to be acceptable, and the acceptability values for each shoe is taken as a label of whether or not such a shoe has unacceptable wrinkles. These labels can be associated with the scanned 3-D models of their corresponding shoes to generate a set of labeled training data, which can then be used to train an AI system based on, for example, a set of Convolutional Neural Networks in order to learn the aggregate shoe inspection knowledge of the human experts.

Variables and attributes of objects are generally also associated with a particular “location” on the object. For example, a length, a width, and a height of a shoe may corresponds to particular directions along the shoe (e.g., the length is along the direction from the heel to the toe, the width is along the direction perpendicular to the length and parallel to the sole of the shoe, and the height is perpendicular to both the length and the width). In addition, the locations of particular features of a shoe, such as the eyelets, logos or other designs on the surface of the shoe may be located at particular coordinates within the coordinate system of the shoe.

Similarly, a defect may be located in a specific location on the boundary or surface of an object. For example, wrinkles or stains may be located a substantially arbitrary portions of a shoe (e.g., a defect in the underlying leather can cause the defect to appear at any part of the shoe that is made of leather) and, therefore, in some embodiments of the present invention, the inference of defects is performed for a set of locations on the object, e.g., specific sets of points in or patches of the 3-D model of the objects to be inspected.

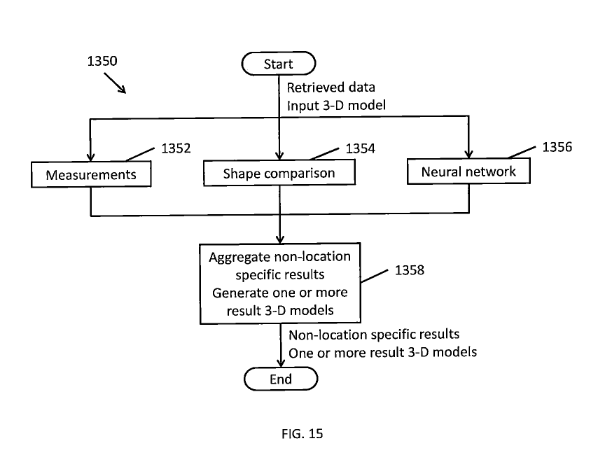

FIG. 15 is a flowchart of a method for detecting defects based on descriptors of locations of features of a target object according to one embodiment of the present invention. In the embodiment shown in FIG. 15, three different types of analyses are performed on an input 3-D model of the object based on retrieved data. These analyses include: measurements in operation 1352; shape comparison in operation 1354; and a neural network analysis in operation 1356. In some embodiments of the present invention, these analyses are performed in parallel. In operation 1358, the results of these analyses are aggregated, and location specific aspects of these analyses may be used to generate one or more result 3-D models for displaying the results of the analyses, as described in more detail below.

The measurement analyses of operation 1352 may include various physical measurements of variables and attributes of the object. As noted above, these measurements can be considered a classical machine vision problem, for which ad-hoc and explicit techniques as well as learning-based techniques can be applied in various embodiments of the present invention. For example, expected measurement values may be retrieved from the database and compared against measurements taken of the scanned 3-D model in accordance with predefined rules. One example of an operation that is performed in one embodiment of the present invention is the computation of a minimum bounding box containing the object and its comparison with the expected size/shape of the identified object (see the example shown in FIG. 1, where the minimum bounding box is used to measure the length, width, and height of a shoe and the values are compared to the expected values retrieved from the database). For example, a minimum bounding box for a three-dimensional model can be computed using the “rotating calipers” method that is known in the art. When the measured value differs from the expected value (e.g., by more than a threshold amount), then a defect is detected. As another example, the locations of particular portions of an object may be compared against expected locations of the object (e.g., the widest part of the shoe may be expected to be located at a particular fraction of the distance along the length of the shoe, where the particular fraction may be independent of the size of the shoe). As another example, the predefined rules may include one or more explicitly defined detectors (e.g., a trained convolutional neural network) configured to detect the presence of a particular shape in an image. Examples of particular shapes that can be detected with such detectors include wrinkles in a surface of a cloth such as leather and the presence of knots in a piece of wood. As a particular example, in the case of the wrinkles on a chair (or the stitches or a logo on a shoe), a trained classifier (e.g., a convolutional neural network) is trained to identify all the points in an acquired image (e.g., given an input image or an input 3-D model) that present that particular feature (e.g., wrinkles in a surface material). The classifier may also be used in conjunction with another stage that implements the predefined rules, such as a threshold (e.g., maximum) number of allowed wrinkles in a region, a maximum width of stitches in shoes, and a maximum area of a logo, in order to classify if the feature is within specification or not.

One example of defect detection according to some embodiments of the present invention is, in operation 1354, the comparison of the shape of the captured input 3-D model with respect to a canonical model of the identified object in order to detect abnormalities by finding differences between the surface of the captured input model and the canonical model. (This technique may be particularly applicable in the case of objects that have a rigid structure.) The locations and magnitudes of differences between the canonical model and the scanned input model can then be recorded on a result 3-D model, where the magnitude of the difference (e.g., the extent to which the shape or color at a location on the captured input 3-D model differs from the canonical 3-D model) can represent the magnitude of the defect.

Another example of defect detection according to some embodiments of the present invention relates to “tessellation” techniques. In some such embodiments, a set of 2-D renderings of local portions of the surface of the 3-D model is generated with rendering techniques exploiting color, geometry, or surface normals information. Each of the generated renderings, generally called patches, is compared against a set of known patches, which generally include a range of defective samples. This comparison can be done directly, by computing a descriptor for instance with a CNN and by applying a neural network classifier or indirectly, i.e., by training a CNN architecture to regress the presence of defect, either in a binary or in a continuous form.

According to some embodiments of the present invention, the defect detection relates to detecting “abnormal” or “outlier” instances of the objects from among the collection of objects. In more detail, in some embodiments of the present invention, a group of 3-D scans of a representative sample of objects (instances) of the same class is collected. For the sake of convenience, it will be assumed that each of these instances is substantially identical in the idea case (e.g., they are all shoes of the model and have the same size) but that the actual instances vary in size and shape due, for example, to variability in the materials, variability in the consistency of the tools used to shape the materials, differences in skill of humans working on the assembly line. and other variability in the processes for manufacturing the objects. Accordingly, under the assumption that the defect rate is relatively low (e.g., that most instances fall within a particular range), an “average” model can be computed from all of the “training” 3-D models of the representative sample of objects. For example, in one embodiment, the 3-D models of the representative samples are aligned (e.g., using iterative closest point). The aligned 3-D models can then be averaged. For example, for each point p₁ on a first model, a closest point p₂ of a second model is identified (e.g., by computing the distances to all points of the second model within a ball around point p₁). The first point p and the second point p₂ will be referred to herein as “corresponding” points of the 3-D models. All of the corresponding points across all of the training 3-D models may be identified and, for each set of corresponding points, an average (e.g., a mean) is computed and the collection of average points may constitute the “average” 3-D model.

In some embodiments, outlier objects are removed from the training 3-D models. and differences between the models are calculated by summing the distances between the closest points between two different models. The “distances” include distance in three-dimensional space (e.g., for a point p₁ on a first model, the distance between point p₁ and a closest point p₂ of a second model), as well as the distance in color space (e.g., the distance between the color p₁(R, G, B) of the first point p and the color p₂(R, G, B) of the second point p₂). Models having larger differences larger than a threshold (e.g., two standard deviations from the mean of the sample) may be referred to as “outlier” or “abnormal” instances. In some embodiments, the mean of the sample is used as the reference model.

In some embodiments of the present invention, generative models (such as Generative Adversarial Networks or GANs) may be used to detect abnormal objects. Generally, a generative model includes two components: a generator, which learns to generate objects from a training set (e.g., training input visual data such as training 3-D models), and a discriminator, which learns to distinguish between the generated samples and the actual samples in the training set. The two components are trained in an adversarial way—the generator tries to fool the discriminator and the discriminator tries to catch the samples from the generator. If the generative model is trained using only “normal” objects (e.g., if the training set contains only “normal” objects) and the trained generative model is given an unknown sample (e.g., input visual data such as an input 3-D model) as input to determine or predict whether the unknown sample is normal (e.g., non-defective) or abnormal (e.g., defective), then the trained generative model transforms the supplied input to generate a transformed output (e.g., output visual data such as an output 3-D model). Accordingly, the unknown input can be predicted as normal or abnormal by calculating a difference between the unknown sample and the transformed output (e.g., determining whether the difference satisfies a threshold). In some embodiments of the present invention, if there are sufficient abnormal (or defective) samples available for use in training, similar generative models are trained with both normal (e.g., non-defective) and abnormal (e.g., defective) these generative models can be used to classify the input objects in a manner similar to that described above for a generative model trained on a training set containing only “normal” objects. Furthermore, in some embodiments, generative models can be used to produce intermediate representations that can be used to classify “normal” versus “abnormal” samples. See, e.g., Goodfellow, Ian, et al. “Generative adversarial nets.” Advances in neural information processing systems. 2014 and Hirose, Noriaki, et al. “GONet: A Semi-Supervised Deep Learning Approach For Traversability Estimation.” arXiv preprint arXiv: 1803.03254 (2018).

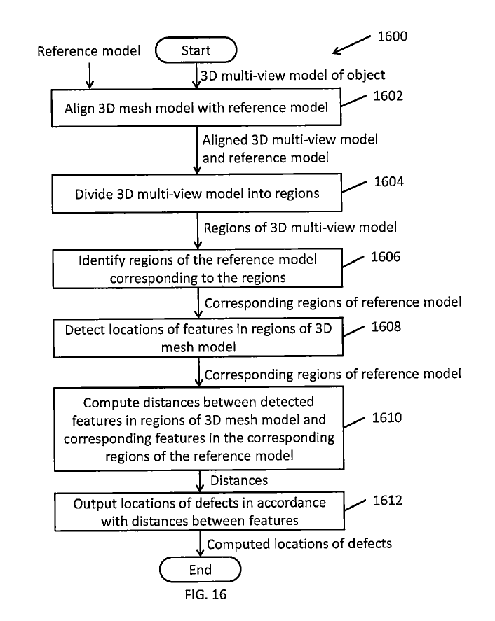

FIG. 16 is a flowchart of a method 1600 for performing defect detection according to one embodiment of the present invention. In operation 1602, the 3-D model analysis module 350 aligns the input scanned 3-D multi-view model and a retrieved reference model (a reference 3-D model representing a canonical instance of the class of objects). In cases where the 3-D multi-view model is a 3-D mesh model or a 3-D point cloud, a technique such as iterative closest point (ICP) can be used to perform the alignment. Techniques for aligning models are also described in U.S. patent application Ser. No. 15/630,715 “Systems and methods for scanning three-dimensional objects,” filed in the United States Patent and Trademark Office on Jun. 22, 2017, the entire disclosure of which is incorporated herein by reference. In embodiments where the 3-D multi-view model is a collection of 2-D images, the alignment may include identifying one or more poses with respect to the reference model that correspond to the views of the object depicted in the 2-D images based on matching shapes depicted in the 2-D images with shapes of the reference model and based on the relative poses of the cameras with respect to the object when the 2-D images were captured.

In operation 1604, the 3-D model analysis module 350 divides the 3-D multi-view model (e.g., the surface of the 3-D multi-view model) into regions. For example, in the case of a shoe, each region may correspond to a particular section of interest of the shoe, such as a region around a manufacturer's logo on the side of the shoe, a region encompassing the stitching along a seam at the heel of the shoe, and a region encompassing the instep of the shoe. In some embodiments, all of the regions, combined, encompass the entire visible surface of the model, but embodiments of the present invention are not limited thereto and the regions may correspond to regions of interest making up less than the entire shoe.

As more specific examples, in embodiments where the 3-D multi-view model is a 3-D mesh model, the region may be a portion of the surface of the 3-D mesh model (e.g., a subset of adjacent triangles from among all of the triangles of the 3-D mesh model). In embodiments where the 3-D multi-view model is a point cloud, the region may be a collection of adjacent points. In embodiments where the 3-D multi-view model is a collection of 2-D images, the region may correspond to the portions of each of the separate 2-D images that depict the particular region of the object (noting that the region generally will not appear in all of the 2-D images, and instead will only appear in a subset of the 2-D images).

In operation 1606, the 3-D model analysis module 350 identifies corresponding regions of the reference model. These regions may be pre-identified (e.g., stored with the reference model), in which case the identifying the corresponding regions in operation 1606 may include accessing the regions. In some embodiments, corresponding regions of the reference model are regions that have substantially similar features as their corresponding regions of the scanned 3-D multi-view model. The features may include particular color, texture, and shape detected in the scanned 3-D multi-view model. For example, a region may correspond to the toe box of a shoe, or a location at which a handle of a handbag is attached to the rest of the handbag. In some embodiments, one or more features of the region of the scanned 3-D multi-view model and the region of the reference model may have substantially the same locations (e.g., range of coordinates) within their corresponding regions. For example, the region containing the toe box of the shoe may include the eyelets of the laces closest to the shoe on one side of the region, the tip of the shoe on the other side of the region.

In embodiments of the present invention where the 3-D multi-view model is a 3-D mesh model and in embodiments of the present invention where the 3-D multi-view model is a point cloud, the region may be, respectively, a collection of adjacent triangles or a collection of adjacent points. In embodiments of the present invention where the 3-D multi-view model is a collection of 2-D images and where the reference model is a 3-D model, the corresponding regions of the reference model may be identified by rendering 2-D views of the reference model from the same relative poses as those of the camera(s) when capturing the 2-D images of the object to generate the 3-D multi-view model.

In operation 1608, the 3-D model analysis module 350 detects locations of features in the regions of the regions of the 3-D multi-view model. The features may be pre-defined by the operator as items of interest within the shape data (e.g., three dimensional coordinates) and texture data (e.g., surface color information) of the 3-D multi-view model and the reference model. In various embodiments, aspects of the features may relate to geometric shape, geometric dimensions and sizes, surface texture and color. One example of a feature is a logo on the side of a shoe. The logo may have a particular size, geometric shape, surface texture, and color (e.g., the logo may be a red cloth patch of a particular shape that is stitched onto the side of the shoe upper during manufacturing). The region containing the logo may be a defined by a portion of the shoe upper bounded above by the eyelets, below by the sole, and to the left and right by the toe box and heel of the shoe. The 3-D model analysis module 350 may detect the location of the logo within the region (e.g., a bounding box containing the logo and/or coordinates of the particular parts of the logo, such as points, corners, patterns of colors, or combinations of shapes such as alphabetic letters). Another example of a feature may relate to the shape of stitches between two pieces of cloth. In such a case, the features may be the locations of the stitches (e.g., the locations of the thread on the cloth within the region). Still another feature may be an undesired feature such as a cut, blemish, or scuff mark on the surface. According to one embodiment of the present invention, the features are detected using a convolutional neural network (CNN) that is trained to detect a particular set of features that are expected to be encountered in the context of the product (e.g., logos, blemishes, stitching, shapes of various parts of the object, and the like), which may slide a detection window across the region to classify various portions of the region as containing one or more features.

In operation 1610, the 3-D model analysis module 350 computes distances (or “difference metrics”) between detected features in regions of 3-D multi-view model and corresponding features in the corresponding regions of the reference model. Referring back to the example of the location of a logo (as a feature of interest) on the side of the shoe, the location of the feature (e.g., the corners of the bounding box) in the region of the 3-D multi-view model is compared with the location of the feature (e.g., the corners of its bounding box) in the corresponding region of the reference model and a distance is computed in accordance with the locations of those features (e.g., as an L1 or Manhattan distance or as a mean squared error between the coordinates). As such, the defects can be detected and characterized in the extent or magnitude of the differences in geometric shape, geometric dimensions and sizes, surface texture and color from a known good (or “reference” sample) or other based on similarity to known defective samples. These features may correspond to different types or classes of defects, such as defects of blemished surfaces, defects of missing parts, defects of uneven stitching, and the like.

The defect detection may be made on a region-by-region basis of the scanned multi-view model and the reference model. For example, when comparing a scanned multi-view model of a shoe with a reference model of the shoe, the comparison may show the distance between the reference position of a logo on the side of the shoe with the actual position of the logo in the scanned model. As another example, the comparison may show the distance between the correct position of an eyelet of the shoe and the actual position of the eyelet.

In some instances, features may be missing entirely from the scanned model, such as if the logo was not applied to the shoe upper during manufacturing. Similarly, features may be detected in the regions of the scanned model that do not exist in the reference model, such as if the logo is applied to a region that should not contain the logo, or if there is a blemish in the region (e.g., scuff marks and other damage to the material). In these cases, in one embodiment, a large distance or difference metric is returned as the computed distance (e.g., a particular, large fixed value) to in order to indicate the complete absence of a feature that is present in the reference model 29 or presence of a feature that is absent from the reference model.

If the differences between the scanned model and the reference model exceed a threshold value, then the quality control system may flag the scanned object as falling outside of the quality control standards in operation 1612. For example, if the location of the logo deviates from the location of the logo in the reference model by more than the threshold distance (where the threshold distance corresponds to an acceptable tolerance level set by the manufacturer). For example, the output of the system may include an indication of the region or regions of the scanned 3-D multi-view model containing detected defects. In addition, the particular portions of the regions representing the detected defect may also be indicated as defective (rather than the entire region). In some embodiments, a defectiveness metric is also output, rather than merely a binary “defective” or “clean” indication. The defectiveness metric may be based on the computed distances, where a larger distance indicates a larger value in the defectiveness metric.

In more detail, in some embodiments of the present invention, a CNN may be trained to detect various types of defects, where the training set includes 3-D models of the objects where defects are to be detected (or various regions of the objects). In some embodiments of the present invention, the 3-D model is supplied as input to the CNN. In other embodiments of the present invention, 2-D renderings of the 3-D multi-view model from various angles are supplied as input to the CNN (e.g., renderings from sufficient angles to encompass the entire surface area of interest). (In embodiments where the 3-D multi-view model includes a plurality of 2-D images, the “2-D renderings” may merely be one or more of those 2-D images.) In still other embodiments of the present invention, the separate regions of the models (e.g., as described above with respect to FIG. 16 and operations 1604 and 1606) are supplied as the inputs to the CNN. The training set includes examples of clean (e.g., defect free objects) as well as examples of defective objects with labels of the types of defects present in those examples.

In some embodiments, the training set is generated by performing 3-D scans of actual defective and clean objects. In some embodiments, the training set also includes input data that is synthesized by modifying the 3-D scans of the actual defective and clean objects and/or by modifying a reference model. These modifications may include introducing blemishes and defects similar to what would be observed in practice. As a specific example, one of the scanned actual defective objects may be a shoe that is missing a grommet in one of its eyelets. However, in practice, any of the eyelets may be missing a grommet, and there may be multiple missing grommets. As such, additional training examples can be generated, where these training examples include every combination of the eyelets having a missing grommet.

Generally, the process of training a neural network also includes validating the trained neural network by supplying a validation set of inputs to the neural network and measuring the error rate of the trained neural network on the validation set. In some embodiments, if the validation error rate and a training error rate (e.g., the error rate of the neural network when given the training set as input) fail to satisfy a threshold, the system may generate additional training data different from the existing training examples using the techniques of modifying the 3-D models of the training data to introduce additional defects of different types. A final test set of data may be used to measure the performance of the trained neural network.

During operation, the trained CNN may be applied to extract a feature vector from a scan of an object under inspection. The feature vector may include color, texture, and shape detected in the scan of the object. The classifier may assign a classification to the object, where the classifications may include being defect-free (or “clean”) or having one or more defects. Some examples of techniques for extracting feature vectors from 3-D models are described in “Systems and methods for automatically generating metadata for media documents,” U.S. patent application Ser. No. 15/675,684, filed in the United States Patent and Trademark Office on Aug. 11, 2017, the entire disclosure of which is incorporate by reference herein.

As such, in some embodiments, a neural network is used in place of computing distances or a difference metric between the scanned 3-D multi-view model and the reference model by instead supplying the scanned 3-D multi-view model (or rendered 2-D views thereof or regions thereof) to the trained convolutional neural network, which outputs the locations of defects in the scanned 3-D multi-view model, as well as a classification of each defect as a particular type of defect from a plurality of different types of defects.

In some embodiments of the present invention, defects are detected using an anomaly detection or outlier detection algorithm. For example, the features in a feature vector of each of the objects may fall within a particular previously observed distribution (e.g., a Gaussian distribution). As such, while most features will have values within a particular range (e.g., a typical range), some objects will have features having values at the extremities of the distribution. In an anomaly detection system, objects having features of their feature vectors with values in the outlier portions of the distribution are detected as having defects in those particular features.

In some embodiments methods similar to multi-dimensional scaling (MDS) are used. Multi-dimensional scaling is a form of non-linear dimensionality reduction, and, in some embodiments, all or a portion of the 3-D surface of the scanned model of the object is converted (e.g., mapped) onto a two-dimensional (2-D) representation. In this mapping, the geodesic distances among the 3-D surface points (that may include surface defects) are substantially maintained in the 2-D representation. Representing all, or a portion, of the 3-D surface using a 2-D encoding allows the use of conventional convolutional neural network (CNN) techniques that are designed to be performed on 2-D images. Because the 2-D representation substantially maintains the 3-D distances between the points, the defects that are categorized by actual real-world sizes can also be detected.

As noted above, aspects of embodiments of the present invention include two general categories of defects that may occur in manufactured objects. The first category of defects or “attributes” includes defects that can be detected by analyzing the appearance of the surface, without metric (e.g., numeric) specifications. More precisely, these defects are such that they can be directly detected on the basis of a learned descriptor vector. These may include, for example: the presence of wrinkles, puckers, bumps or dents on a surface that is expected to be flat; two joining parts that are out of alignment; the presence of a gap where two surfaces are supposed to be touching each other. These defects can be reliably detected by a system trained (e.g., a trained neural network) with enough examples of defective and non-defective units.

The second category of defects or “variables” includes defects that are defined based on a specific measurement of a characteristic of the object or of its surfaces, such as the maximum width of a zipper line, the maximum number of wrinkles in a portion of the surface, or the length or width tolerance for a part.

In various embodiments of the present invention, these two categories are addressed using different technological approaches, as discussed in more detail below. It should be clear that the boundary between these two categories is not well defined, and some types of defects can be detected by both systems (and thus could be detected with either one of the systems described in the following).

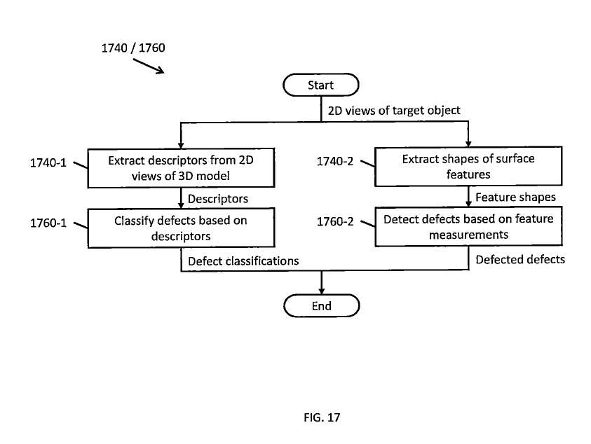

Accordingly, FIG. 17 is a flowchart illustrating a descriptor extraction stage 1740 and a defect detection stage 1760 according to one embodiment of the present invention. In particular, the 2-D views of the target object that were generated by the 3-D model generator 200 and the view generation module 312 can be supplied to detect defects using the first category techniques of extracting descriptors from the 2-D views of the 3-D model in operation 1740-1 and classifying defects based on the descriptors in operation 1760-1 or using the second category techniques of extracting the shapes of regions corresponding to surface features in operation 1740-2 and detecting defects based on measurements of the shapes of the features in operation 1760-2.

Category 1 Defect Detection

Defects in category 1 can be detected using a trained classifier that takes in as input the 2-D views of the 3-D model of a surface or of a surface part, and produces a binary output indicating the presence of a defect. In some embodiments of the present invention, the classifier produces a vector of numbers, where each number corresponds to a different possible defect class and the number represents, for example, the posterior probability distribution that the input data contains an instance of the corresponding defect class. In some embodiments, this classifier is implemented as the cascade of a convolutional network (e.g., a network of convolutional layers) and of a fully connected network, applied to a multi-view representation of the surface. Note that this is just one possible implementation; other types of statistical classifiers could be employed for this task.

A convolutional neural network having substantially similar architecture to that shown in FIG. 11 may be used according to one embodiment of the present invention. According to some embodiments of the present invention, a convolutional neural network (CNN) is used to process the synthesized 2-D views 16 (see FIG. 7) to generate the defect classification of the object. Generally, a deep CNN processes an image by passing the input image data (e.g., a synthesized 2-D view) through a cascade of layers. These layers can be grouped into multiple stages. The deep convolutional neural network shown in FIG. 11 includes two stages, a first stage CNN₁ made up of N layers (or sub-processes) and a second stage CNN₂ made up of M layers. In one embodiment, each of the N layers of the first stage CNN1 includes a bank of linear convolution layers, followed by a point non-linearity layer and a non-linear data reduction layer. In contrast, each of the M layers of the second stage CNN2 is a fully connected layer. The output p of the second stage is a class-assignment probability distribution. For example, if the CNN is trained to assign input images to one of k different classes, then the output of the second stage CNN₂ is an output vector p that includes k different values, each value representing the probability (or “confidence”) that the input image should be assigned the corresponding defect class (e.g., containing a tear, a wrinkle, discoloration or marring of fabric, missing component, etc.).

The computational module that produces a descriptor vector from a 3-D surface is characterized by a number of parameters. In this case, the parameters may include the number of layers in the first stage CNN₁ and the second stage CNN₂, the coefficients of the filters, etc. Proper parameter assignment helps to produce a descriptor vector that can effectively characterize the relevant and discriminative features enabling accurate defect detection. A machine learning system such as a CNN “learns” some of these parameters from the analysis of properly labeled input “training” data.

The parameters of the system are typically learned by processing a large number of input data vectors, where the real (“ground truth”) class label of each input data vector is known. For example, the system could be presented with a number of 3-D scans of non-defective items, as well as of defective items. The system could also be informed of which 3-D scan corresponds to a defective or non-defective item, and possibly of the defect type. Optionally, the system could be provided with the location of a defect. For example, given a 3-D point cloud representation of the object surface, the points corresponding to a defective area can be marked with an appropriate label. The supplied 3-D training data may be processed by the shape to appearance converter 250 to generate 2-D views (in some embodiments, with depth channels) to be supplied as input to train one or more convolutional neural networks 310.

Training a classifier generally involves the use of enough labeled training data for all considered classes. For example, the training set for training a defect detection system according to some embodiments of the present invention contains a large number of non-defective items as well as a large number of defective items for each one of the considered defect classes. If too few samples are presented to the system, the classifier may learn the appearance of the specific samples, but might not correctly generalize to samples that look different from the training samples (a phenomenon called “overfitting”). In other words, during training, the classifier needs to observe enough samples for it to form an internal model of the general appearance of all samples in each class, rather than just the specific appearance of the samples used for training.

The parameters of the neural network (e.g., the weights of the connections between the layers) can be learned from the training data using standard processes for training neural network such as backpropagation and gradient descent (see, e.g., LeCun, Y., & Bengio, Y. (1995). Convolutional networks for images, speech, and time series. The handbook of brain theory and neural networks, 3361(10), 1995.). In addition, the training process may be initialized using parameters from a pre-trained general-purpose image classification neural network (see, e.g., Chatfield, K., Simonyan, K., Vedaldi, A., & Zisserman, A. (2014). Return of the devil in the details: Delving deep into convolutional nets. arXiv preprint arXiv: 1405.3531.).

In order to train the system, one also needs to define a “cost” function that assigns, for each input training data vector, a number that depends on the output produced by the system and the “ground truth” class label of the input data vector. The cost function should penalize incorrect results produced by the system. Appropriate techniques (e.g., stochastic gradient descent) can be used to optimize the parameters of the network over the whole training data set, by minimizing a cumulative value encompassing all individual costs. Note that changing the cost function results in a different set of network parameters.

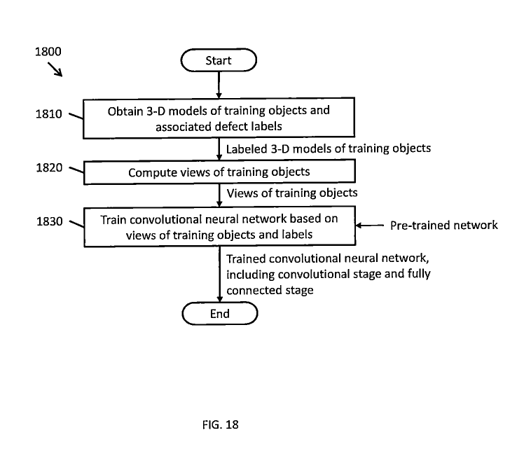

FIG. 18 is a flowchart of a method for training a convolutional neural network according to one embodiment of the present invention. In operation 1810, a training system obtains three-dimensional models of the training objects and corresponding labels. This may include, for example, receiving 3-D scans of actual defective and non-defective objects from the intended environment in which the defect detection system will be applied. The corresponding defect labels may be manually entered by a human using, for example, a graphical user interface, to indicate which parts of the 3-D models of the training objects correspond to defects, as well as the class or classification of the defect (e.g., a tear, a wrinkle, too many folds, and the like), where the number of classes may correspond to the length k of the output vector p. In operation 1820, the training system uses the shape to appearance converter 200 to convert the received 3-D models 14d and 14c of the training objects into views 16d and 16c of the training objects. The labels of defects may also be transformed during this operation to continue to refer to particular portions of the views 16d and 16c of the training objects. For example, a tear in the fabric of a defective training object may be labeled in the 3-D model as a portion of the surface of the 3-D model. This tear is similarly labeled in the generated views of the defective object that depict the tear (and the tear would not be labeled in generated views of the defective object that do not depict the tear).

In operation 1830, the training system trains a convolutional neural network based on the views and the labels. In some embodiments, a pre-trained network or pre-training parameters may be supplied as a starting point for the network (e.g., rather than beginning the training from a convolutional neural network configured with a set of random weights). As a result of the training process in operation 1830, the training system produces a trained neural network 310, which may have a convolutional stage CNN₁ and a fully connected stage CNN₂, as shown in FIG. 11. As noted above, each of the k entries of the output vector p represents the probability that the input image exhibits the corresponding one of the k classes of defects.

As noted above, embodiments of the present invention may be implemented on suitable general purpose computing platforms, such as general purpose computer processors and application specific computer processors. For example, graphical processing units (GPUs) and other vector processors (e.g., single instruction multiple data or SIMD instruction sets of general purpose processors or a Google® Tensor Processing Unit (TPU)) are often well suited to performing the training and operation of neural networks.

Training a CNN is a time-consuming operation, and requires a vast amount of training data. It is common practice to start from a CNN previously trained on a (typically large) data set (pre-training), then re-train it using a different (typically smaller) set with data sampled from the specific application of interest, where the re-training starts from the parameter vector obtained in the prior optimization (this operation is called fine-tuning Chatfield, K., Simonyan, K., Vedaldi, A., & Zisserman, A. (2014). Return of the devil in the details: Delving deep into convolutional nets. arXiv preprint arXiv:1405.3531.). The data set used for pre-training and for fine-tuning may be labeled using the same object taxonomy, or even using different object taxonomies (transfer learning).

Accordingly, the parts based approach and patch based approach described above can reduce the training time by reducing the number of possible classes that need to be detected. For example, in the case of a car seat or a chair, the types of defects that may appear on the front side of a seat back may be significantly different from the defects that are to be detected on the back side of the seat back. In particular, the back side of a seat back may be a mostly smooth surface of a single material, and therefore the types of defects may be limited to tears, wrinkles, and scuff marks on the material. On the other hand, the front side of a seat back may include complex stitching and different materials than the seat back, which results in particular expected contours. Because the types of defects found the front side and back side of a seat back are different, it is generally easier to train two separate convolutional neural networks for detecting a smaller number of defect classes (e.g., k_{back} and k_{front}) than to train a single convolutional neural network for detecting the sum of those numbers of defect classes (e.g., k_{back}+k_{front}). Accordingly, in some embodiments, different convolutional neural networks 310 are trained to detect defects in different parts of the object, and, in some embodiments, different convolutional neural networks 310 are trained to detect different classes or types of defects. These embodiments allow the resulting convolutional neural networks to be fine-tuned to detect particular types of defects and/or to detect defects in particular parts.

Therefore, in some embodiments of the present invention, a separate convolutional neural network is trained for each part of the object to be analyzed. In some embodiments, a separate convolutional neural network may also be trained each separate defect to be detected.

As shown in FIG. 11, the values computed by the first stage CNN₁ (the convolutional stage) and supplied to the second stage CNN₂ (the fully connected stage) are referred to herein as a descriptor (or feature vector) f. The descriptor may be a vector of data having a fixed size (e.g., 4,096 entries) which condenses or summarizes the main characteristics of the input image. As such, the first stage CNN₁ may be used as a feature extraction stage of the defect detector 300.

In some embodiments the views may be supplied to the first stage CNN₁ directly, such as in the case of single rendered patches of the 3-D model or single views of a side of the object. FIG. 13 is a schematic diagram of a max-pooling neural network according to one embodiment of the present invention. As shown in FIG. 13, the architecture of a classifier 310 described above with respect to FIG. 11 can be applied to classifying multi-view shape representations of 3-D objects based on n different 2-D views of the object. These n different 2-D views may include circumstances where the virtual camera is moved to different poses with respect to the 3-D model of the target object, circumstances where the pose of the virtual camera and the 3-D model is kept constant and the virtual illumination source is modified (e.g., location), and combinations thereof (e.g., where the rendering is performed multiple times with different illumination for each camera pose).

For example, the first stage CNN₁ can be applied independently to each of the n 2-D views used to represent the 3-D shape, thereby computing a set of n feature vectors f(1), f(2), . . . , f(n) (one for each of the 2-D views). In the max pooling stage, a pooled vector F is generated from the n feature vectors, where the i-th entry F; of the pooled feature vector is equal to the maximum of the i-th entries of the n feature vectors (e.g., F=max(fᵢ(1), fᵢ(2), . . . , fᵢ(n)) for all Indices i in the Length of the Feature Vector, Such as for entries 1 through 4,096 in the example above). Aspects of this technique are described in more detail in, for example, Su, H., Maji, S., Kalogerakis, E., & Learned-Miller, E. (2015). Multi-view convolutional neural networks for 3-D shape recognition. In Proceedings of the IEEE International Conference on Computer Vision (pp. 945-953). In some embodiments, the n separate feature vectors are combined using, for example, max pooling (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).).

Some aspects of embodiments of the present invention are directed to the use of max-pooling to mitigate some of the pose invariance issues described above. In some embodiments of the present invention, the selection of particular poses of the virtual cameras, e.g., the selection of which particular 2-D views to render, results in a descriptor F having properties that are invariant. For example, considering a configuration where all the virtual cameras are located on a sphere (e.g., all arranged at poses that are at the same distance from the center of the 3-D model or a particular point p on the ground plane, and all having optical axes that intersect at the center of the 3-D model or at the particular point p on the ground plane). Another example of an arrangement with similar properties includes all of the virtual cameras located at the same elevation above the ground plane of the 3-D model, oriented toward the 3-D model (e.g., having optical axes intersecting with the center of the 3-D model), and at the same distance from the 3-D model, in which case any rotation of the object around a vertical axis (e.g., perpendicular to the ground plane) extending through the center of the 3-D model will result in essentially the same vector or descriptor F (assuming that the cameras are placed at closely spaced locations).

Performing Defect Detection Using the Trained CNN

Given a trained convolutional neural network, including convolutional stage CNN₁ and fully connected stage CNN₂, in some embodiments, the views of the target object computed in operation 420 are supplied to the convolutional stage CNN₁ of the convolutional neural network 310 in operation 440-1 to compute descriptors f or pooled descriptors F. The views may be among the various types of views described above, including single views or multi-views of the entire object, single views or multi-views of a separate part of the object, and single views or multi-views (e.g., with different illumination) of single patches. The resulting descriptors are then supplied in operation 460-1 as input to the fully connected stage CNN₂ to generate one or more defect classifications (e.g., using the fully connected stage CNN₂ in a forward propagation mode). The resulting output is a set of defect classes.

As discussed above, multiple convolutional neural networks 310 may be trained to detect different types of defects and/or to detect defects in particular parts (or segments) of the entire object. Therefore, all of these convolutional neural networks 310 may be used when computing descriptors and detecting defects in the captured image data of the target object.

In some embodiments of the present invention in which the input images are defined in segments, it is useful to apply a convolutional neural network that can classify a defect and identify the location of the defect in the input in one shot. Because the network accepts and processes a rather large and semantically identifiable segment of an object under test, it can reason globally for that segment and preserve the contextual information about the defect. For instance, if a wrinkle appears symmetrically in a segment of a product, that may be considered acceptable, whereas if the same shape wrinkle appeared on only one side of the segment under test, it should be flagged as defect. Examples of convolutional neural networks that can classify a defect and identify the location of the defect in the input in one shot as described in, for example, Redmon, Joseph, et al. “You only look once: Unified, real-time object detection.” Proceedings of the IEEE conference on computer vision and pattern recognition. 2016. and Liu, Wei, et al. “SSD: Single shot multibox detector.” European conference on computer vision. Springer, Cham, 2016.

Computing Distances Between Descriptors

Another approach to defect detection in the face of limited access to defective examples for training is to declare as “defective” an object that, under an appropriate metric, has appearance that is substantially different from a properly aligned non-defective model object. Therefore, in some embodiments of the present invention, in operation 1760-1, the discrepancy between a target object and a reference object surface is measured by the distance between their descriptors f or F (the descriptors computed in operation 1740-1 as described above with respect to the outputs of the first stage CNN₁ of the convolutional neural network 310). Descriptor vectors represent a succinct description of the relevant content of the surface. If the distance of the descriptor vectors of a model to the descriptor vector of the sample surface exceeds a threshold, then the unit can be deemed to be defective. This approach is very simple and can be considered an instance of “one-class classifier” (see, e.g., Manevitz, L. M., & Yousef, M. (2001). One-class SVMs for document classification. Journal of Machine Learning Research, 2(December), 139-154.).

In some embodiments, a similarity metric is defined to measure the distance between any two given descriptors (vectors) F and F_{ds}(m). Some simple examples of similarity metrics are a Euclidean vector distance and a Mahalanobis vector distance. In other embodiments of the present invention a similarity metric is learned using a metric learning algorithm (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).). A metric learning algorithm may learn a linear or non-linear transformation of feature vector space that minimizes the average distance between vector pairs belonging to the same class (as measured from examples in the training data) and maximizes the average distance between vector pairs belonging to different classes.

In some cases, non-defective samples of the same object model may have different appearances. For example, in the case of a leather handbag, non-defective folds on the leather surface may occur at different locations. Therefore, in some embodiments, multiple representative non-defective units are acquired and their corresponding descriptors are stored. When performing the defect detection operation 1760-1 on a target object, the 3-D model analysis module 350 computes distances between the descriptor of the target unit and the descriptors of each of the stored non-defective units. In some embodiments, the smallest such distance is used to decide whether the target object is defective or not, where the target object is determined to be non-defective if the distance is less than a threshold distance and determined to be defective if the distance is greater than the threshold distance.

A similar approach can be used to take any available defective samples into consideration. The ability to access multiple defective samples allows the defect detection system to better determine whether a new sample should be considered defective or not. Given the available set of non-defective and of defective part surfaces (as represented via their descriptors), in some embodiments, the 3-D model analysis module 350 computes the distance between the descriptor of the target object under consideration and the descriptor of each such non-defective and defective samples. The 3-D model analysis module 350 uses the resulting set of distances to determine the presence of a defect. For example, in some embodiments, the 3-D model analysis module 350 determines in operation 1760-1 that the target object is non-defective if its descriptor is closest to that of a non-defective sample, and determines the target object to exhibit a particular defect if its descriptor is closest to a sample with the same defect type. This can be considered as an instance of a nearest neighbor classifier Bishop, C. M. (2006). Pattern recognition and Machine Learning, 128, 1-58. Possible variations of this method include a k-nearest neighbor strategy, whereby the k closest neighbors (in descriptor space) in the cumulative set of stored samples are computed for a reasonable value of k (e.g., k=3). The target object is then labeled as defective or non-defective depending on the number of defective and non-defective samples in the set of k closest neighbors. It is also important to note that, from the descriptor distance of a target object and the closest sample (or samples) in the data set, it is possible to derive a measure of “confidence” of classification. For example, classification of a target object whose descriptor has comparable distance to the closest non-defective and to the closest defective samples in the data set could be considered to be difficult to classify, and thus receive a low confidence score. On the other hand, if a unit is very close in descriptor space to a non-defective sample, and far from any available defective sample, it could be classified as non-defective with high confidence score.

The quality of the resulting classification depends on the ability of the descriptors (computed as described above) to convey discriminative information about the surfaces. In some embodiments, the network used to compute the descriptors is tuned based on the available samples. This can be achieved, for example, using a “Siamese network” trained with a contrastive loss (see, e.g., Chopra, S., Hadsell, R., and LeCun, Y. (2005, June). Learning a similarity metric discriminatively, with application to face verification. In Computer Vision and Pattern Recognition, 2005. CVPR 2005. IEEE Computer Society Conference on (Vol. 1, pp. 539-546). IEEE.) Contrastive loss encourages descriptors of objects within the same class (defective or non-defective) to have small Euclidean distance, and penalizes descriptors of objects from different classes with similar Euclidean distance. A similar effect can be obtained using known methods of “metric learning” (see, e.g., Weinberger, K. Q., Blitzer, J., & Saul, L. (2006). Distance metric learning for large margin nearest neighbor classification. Advances in neural information processing systems, 18, 1473.).

According to some embodiment of the present invention, an “anomaly detection” approach may be used to detect defects. Such approaches may be useful when defects are relatively rare and most of the training data corresponds to a wide range of non-defective samples. According to one embodiment of the present invention, descriptors are computed for every sample of the training data of non-defective samples. Assuming that each entry of the descriptors falls within a normal (or Gaussian) distribution and that all of the non-defective samples lies within some distance (e.g., two standard deviations) of the mean of the distribution, descriptors that fall outside of the distance are considered to be anomalous or defective.

Category 2 Defect Detection

In some embodiments, category 2 defects are detected through a two-step process. Referring to FIG. 17, the first step 1740-2 includes the automatic identification of specific “features” in the surface of the target object. For example, for a leather bag, features of interest could be the seams connecting two panels, or each individual leather fold. For a car seat, features of interest could include a zipper line, a wrinkle on a leather panel, or a noticeable pucker at a seam. These features are not, by themselves, indicative of a defect. Instead, the presence of a defect can be inferred from specific spatial measurements of the detected features, as performed in operation 1760-2. For example, the manufacturer may determine that a unit is defective if it has more than, say, five wrinkles on a side panel, or if a zipper line deviates by more than 1 cm from a straight line. These types of measurements can be performed once the features have been segmented out of the captured image data (e.g., depth images) in operation 1740-2.

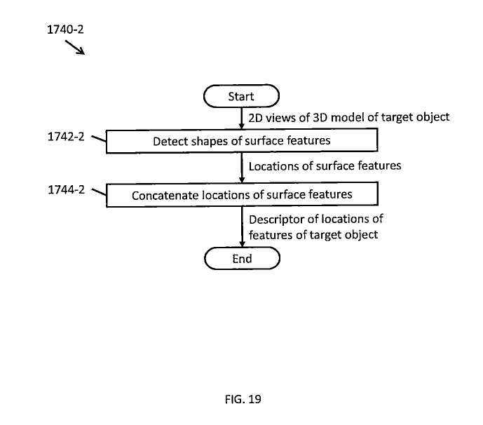

FIG. 19 is a flowchart of a method for generating descriptors of locations of features of a target object according to one embodiment of the present invention. In some embodiments of the present invention, feature detection and segmentation of operation 1740-2 is performed using a convolutional neural network that is trained to identify the locations of labeled surface features (e.g., wrinkles, zipper lines, and folds) in operation 1742-2. According to some embodiments of the present invention, a feature detecting convolutional neural network is trained using a large number of samples containing the features of interest, where these features have been correctly labeled (e.g., by hand). In some circumstances, this means that each surface element (e.g., points in the acquired point cloud, or triangular facets in a mesh) are assigned a tag indicating whether they correspond to a feature, and if so, an identifier (ID) corresponding to the feature. Hand labeling of a surface can be accomplished using software with a suitable user interface. In some embodiments, in operation 1744-2, the locations of the surface features are combined (e.g., concatenated) to form a descriptor of the locations of the features of the target object. The feature detecting convolutional neural network is trained to label the regions of the two-dimensions that correspond to particular trained features of the surface of the 3-D model (e.g., seams, wrinkles, stitches, patches, tears, folds, and the like).

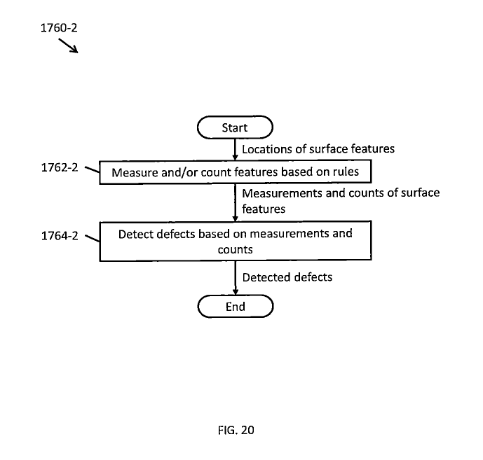

FIG. 20 is a flowchart of a method for detecting defects based on descriptors of locations of features of a target object according to one embodiment of the present invention. In some embodiments of the present invention, explicit rules may be supplied by the user for determining, in operation 1760-2, whether a particular defect exists in the target object by measuring and/or counting, in operation 1762-2, the locations of the features identified in operation 1740-2. As noted above, in some embodiments, defects are detected in operation 1764-2 by comparing the measurements and/or counts with threshold levels, such as by counting the number of wrinkles detected in a part (e.g., a side panel) and comparing the counted number to a threshold number of wrinkles that are within tolerance thresholds. When the 3-D model analysis module 350 determines that the counting and/or measurement is within the tolerance thresholds, then the object (or part thereof) is labeled as being non-defective, and when the counting and/or measurement is outside of a tolerance threshold, then the 3-D model analysis module 350 labels the object (or part thereof) as being defective (e.g., assigns a defect classification corresponding to the measurement or count). The measurements may also relate to the size of objects (e.g., the length of stitching) and ensuring that the measured stitching is within an expected range (e.g., about 5 cm). The depth measurements may also be used to perform measurements. For example, wrinkles having a depth greater than 0.5 mm may be determined to indicate a defect while wrinkles having a smaller depth may be determined to be non-defective.

Referring back to FIG. 17, the defects detected through the category 1 process of operations 1740-1 and 1760-1 and the defects detected through the category 2 process of operations 1740-2 and 1760-2 can be combined and displayed to a user, e.g., on a display panel of a user interface device (e.g., a tablet computer, a desktop computer, or other terminal) to highlight the locations of defects, as described in more detail below.

In some embodiments of the present invention, multiple analyses are performed on the captured input 3-D model. For example, the measurements and tessellation based analyses may both be performed. As another example, both the comparison with the canonical model and the tessellation technique may both be performed on the input 3-D model. Generally speaking, any combination of analyses of the 3-D model may be performed in series or in parallel (or combinations thereof) to analyze characteristics of the scanned object based on its captured 3-D model.

Examples of systems and methods for performing defect detection are described in more detail in U.S. patent application Ser. No. 15/678,075, “METHOD AND SYSTEM FOR SIMULTANEOUS 3D SCANNING AND CAPTURING BRDF WITH HAND-HELD SCANNER,” filed in the United States Patent and Trademark Office on Aug. 15, 2017; U.S. patent application Ser. No. 15/866,217, “SYSTEMS AND METHODS FOR DEFECT DETECTION,” filed in the United States Patent and Trademark Office on Jan. 9, 2018; and U.S. patent application Ser. No. 15/974,595, “SYSTEMS AND METHODS FOR INSPECTION AND DEFECT DETECTION USING 3-D SCANNING,” filed in the United States Patent and Trademark Office on May 8, 2018, the entire disclosures of which are incorporated by reference herein.

The inspection agent or inspection system 300 generates analysis results for the scanned query object, which, in various embodiments of the present invention, include one or more of the various variables and attributes described above. These variables and attributes may include: retrieved metadata about expected characteristics of the class of the object; physical measurements of the object (e.g., dimensions, locations of surface features of the object); and one or more result 3-D models that depict the locations of detected defects (e.g., each 3-D model may depict a different type of defect or a 3-D model may depict multiple different types of defects).

Display of Results

Some aspects of embodiments of the present invention relate to displaying the results of the analysis generated by the inspection agent 300 on a display device system 400, where the results of the analysis are displayed in association with (e.g., adjacent and/or overlapping) the view of the object through the display device system 400. In particular, some aspects of embodiments of the present invention relate to overlaying the location-specific computed values and attributes of the object on the particular locations of the object that they are associated with. Continuing the above example, in the case of measuring the length, width, and height of an object, in some embodiments, the particular measured dimension values are overlaid along their corresponding axes of the shoe (see, e.g., FIG. 1). As the object rigidly transforms within the view (e.g., is rotated or translated), the display device system 400 automatically tracks the rigid transformation of the real-world object and updates the displayed data accordingly. For example, if the shoe shown in FIG. 1 is rotated about its length axis so that its sole is perpendicular to the view, the line representing the width of the shoe also rigidly transforms (e.g., rotates in three dimensions) in the view so that the line remains aligned with the width of the shoe (but now perhaps pointing vertically in the figure). In this example, the line corresponding to the height of the shoe may be very short or may substantially disappear if it is “foreshortened” in the view.

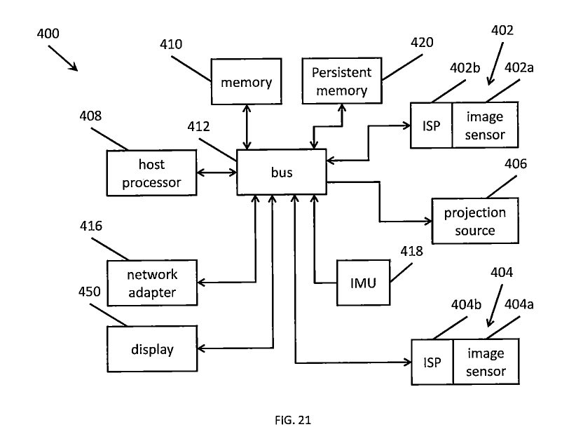

FIG. 21 is a block diagram of a display device system according to one embodiment of the present invention. As shown in FIG. 21, the display device system 400 includes a processor 408 and a memory 410 storing instructions for controlling the display device system 400. The display device system 400 may include a display 450 for displaying the results of the analysis to a user. The display device system 400 may also include sensing components for sensing the position of an object relative to the display device system 400. In FIG. 21, the sensing components are shown as cameras 402 and 404, each of which includes image sensors 402a and 404a and image signal processors (ISPs) 402b and 404b. FIG. 21 also depicts an infrared projection source 406 configured to project infrared light toward the view of the scene 18 containing the object 10 (see, e.g., FIG. 1).

In some embodiments of the present invention, the display 450 of the display device system 400 is a component of a head mounted display (HMD) such as a pair of smart glasses. The HMD may also include an inertial measurement unit 418 as well as the sensing components. The HMD may include the host processor 408, memory 410, bus 412, and the like, or these components may be mounted off of the user's head (e.g., in a device clipped to the user's belt or in a user's pocket).

In some embodiments of the present invention, the display 450 of the display device system 400 is a display panel such as a computer monitor or a television, which displays a view of the object 10 as captured by a camera (e.g., one of the cameras 402 or 404 of the sensing components, or another camera separate from the sensing components). In such embodiments, the IMU 418 may not be necessary, as the location of the camera may be relatively fixed and can be calibrated with respect to the sensing components such that the relative pose of the sensing components and the view provided by the camera is known.

In some embodiments of the present invention, the scanning system 100 and/or the inspection system 300 are integrated into the display device system 400. For example, in embodiments in which the scanning system 100 is integrated into the display device system, the sensing components of the display device system may include one or more depth cameras, which capture images of the object for use in generating the 3-D model of the object. In embodiments in which the inspection system 300 is integrated into the display device system, the processing to, for example, make measurements of the object and to detect defects or abnormalities of the object are performed locally at the display device system.

In embodiments of the present invention in which the inspection system 300 is not integrated in the display device system 400, the inspection analysis results (e.g., the 3-D model, the one or more result 3-D models, and other result data from the inspection agent 300) may be transmitted to the display device through a computer network to a network adapter 416 of the display device system 400, based on, for instance, TCP/IP, UDP/IP, or custom networking protocols, and by using wireless or wireless networking infrastructures and protocols, such as IEEE 802.11b/g/n/ac and IEEE 802.3. In some embodiments, other types of data communications technologies such as Bluetooth®, Universal Serial Bus (USB), and the like may be used to transfer data between the inspection system 300 and the display device system 400. In embodiments in which the inspection system 300 is integrated in the display device system 400 (e.g., by implementing some or all of the descriptor extractor module 310, data retrieval module 330, and 3-D model analysis module 350 in the processor 408 and memory 410 of the display device system 400), the data generated by the inspection agent 300 may be stored in the memory 410 and/or the persistent memory 420 of the display device after being generated by the inspection agent 300 and loaded by the display device system 400 to be shown on the display 450.

In some embodiments of the present invention, the display device system 400 includes an augmented reality-head mounted display (AR-HMD) device, which allows the inspection output 20 and 30 (see FIG. 1) to be directly associated with the actual real-world object 10 being inspected. For example, in some embodiments, the AR-HMD device includes a transparent (e.g., see-through) display 450 (which can be constituted by one or more optical components), with a visual system for displaying information on the transparent display, and with a set of positioning sensors, such as inertial measurement units (IMUs). Accordingly, the inspection output 20 can be overlaid over the view of the actual real-world object 10 through the transparent display 450.

In some embodiments of the present invention, the display device system 400 includes a display panel 450 (e.g., a computer monitor, a television, or the display panel of a tablet computer, a smartphone, and the like). In some embodiments, a camera (e.g., a color camera) is directed toward the object and the images captured by the camera are shown on the display device (e.g., as a live or real-time video stream). The inspection output can then be overlaid onto (or composited with) the images captured by the camera when shown on the display device, where the inspection output is displayed in association with the object (e.g., overlaying dimensions of the object along the corresponding axes of the image of the object on the display, and/or highlighting locations of the defect in the image of the object on the display).

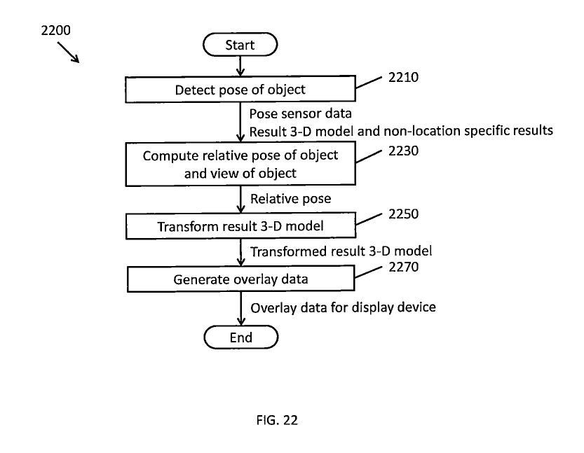

FIG. 22 is a flowchart illustrating a method for displaying the results of the analysis according to one embodiment of the present invention. In operation 2210, one or more sensing components detect an object relative to the display device. For example, in the case where the one or more sensing components associated with the display device system 400 include cameras, one or more images of the object may be captured by the cameras. In other embodiments of the present invention, other types of sensing components may be used, such as a single 2-D camera, a depth camera (e.g., an active stereo depth camera or a time-of-flight depth camera), and the like.

After detecting the object 10 using the sensing components, the display device system 400 also loads the appropriate analysis result data (e.g., generated by the inspection agent 300) associated with the detected object. For example, the scanning of the object by the scanning system 99 may occur some distance away from the display device system 400, and there may be several intervening objects (e.g., on the conveyor belt) between the scanning system 99 and the display device 400. In some embodiments of the present invention, it is assumed that the objects on the conveyor belt remaining in the same order (e.g., in a queue or in a first-in-first out (FIFO) order). As such, the analysis results data are presented to the system on an object-by-object basis in the same order in which the objects 10 are scanned by the scanning system 99 (e.g., the analysis results are also stored or buffered in a queue (first-in-first-out) data structure, where an analysis result generated by the inspection system 300 are added to the tail of the queue and an analysis result is taken from the head of the queue when a new object is detected by the sensing components). In some embodiments of the present invention, each object 10 is associated with a visual code (e.g., a 1-D barcode, a 2-D barcode such as a QR code, or other identifier), where the visual code may be applied directly to the object itself or to a portion of the conveying system configured to carry the object (e.g., applied to a tray holding the object or printed onto the conveyor belt 12 carrying the objects). When the object 10 is scanned by the scanning system 99, the visual code is captured and the visual code (or the value encoded therein) is associated with the captured 3-D model. Accordingly, the visual code (or the value encoded therein) may also be provided to the inspection agent with the captured 3-D model and the inspection agent 300 associates the value of the visual code with the generated analysis results (e.g., the value of the visual code may serve as a key to lookup the associated value in a key-value store). Accordingly, when the sensing components of the display device system 400 capture images of object 10, the visual code is also captured and the code is used to retrieve the analysis from storage (e.g., the key-value store).

The analysis result data may include a result 3-D model, in which the shape of the result 3-D model may generally correspond to the shape of the object and in which defects and/or abnormalities in the object, as detected by the inspection agent 300, are highlighted in the result 3-D model.

In operation 2230, the display device system 400 calculates a pose of the object detected by the one or more sensing components to calculate a pose of the object relative to the view of the display device. In the case of a display device that displays the view of the object as captured by a camera (such as a display panel displaying a view captured by a camera of the sensing components associated with the display device), the relative pose can be determined merely by computing the pose of the object relative to the camera that is capturing the images shown on the display panel, because the coordinate system of the camera may be treated as a world coordinate system.

On the other hand, in the case of an AR-HMD device, the sensing components of the AR-HMD can be used to detect the relative pose of the AR-HMD with respect to a world reference frame as well as the relative pose of the object with respect to the AR-HMD. This allows the displayed data to track the location of the object within the view through the AR-HMD system while keeping some parts of the data relatively still (e.g., keeping text along a baseline that is perpendicular to gravity when the AR-HMD is within a range of poses). The sensing components may include cameras (e.g., color cameras and/or depth cameras) to capture information about the environment and positioning sensors (e.g., IMUs) to capture information about the orientation of the AR-HMD system.

In some embodiments, the sensing components of the display device system 400 may include only one camera for detecting the pose of the object in the frame and, accordingly, the display device system 400 performs scale-less alignment with respect to the framed object by identifying an orientation of the 3-D model that matches the appearance of the object in the view of the one camera. If a (possibly partial) 3-D model of the object being inspected is available (e.g., the 3-D model captured by the scanning system 99), it is possible to resolve the scale ambiguity of the object even in embodiments in which only a single camera is present in the sensing components. In some embodiments, this is accomplished by computing the relative pose between the images acquired by the camera of the sensing components of the display device system 400 and the 3-D model of the object and by associating the scale information intrinsic in the 3-D model to the image, e.g., by rendering the 3-D model. This type of operation is greatly simplified in the case in which intrinsic parameters (e.g., focal, optical center and distortion coefficients) are available for the camera(s), either by offline or by automatic-calibration.

In some embodiments of the present invention, the alignment of the images acquired by the camera(s) with the object to compute the relative pose of the object and the view of the object in operation 2230 can be performed by applying Structure-from-Motion (SfM) and Pose-Estimation techniques. One component of these approach includes the computation of image keypoints (also called “features”), such as the scale-invariant feature transform (SIFT), KAZE, and Harris corner feature detectors. In some embodiments of the present invention, the keypoint detector is implemented by instructions stored in the memory, and executed by the processor of, a computing device associated with the display device system 400. In some embodiments of the present invention, the keypoint detector is implemented by dedicated hardware, such as a field programmable gate array (FPGA) or an application specific integrated circuit (ASIC), which may allow lower latency (both of which may be important to keeping the generated overlay of data aligned with the view of the object 10 through the display 450) and lower power consumption (which may be particularly applicable in the case of a portable device such as a tablet computer or an AR-HMD). In one embodiment, the computation of these keypoints is performed by regressing a Convolutional Neural Network that includes at least two layers, with eventually discretized coefficients (e.g., 8, 16, 32 or 64 bit coefficients) in order to approximate a standard feature detector, e.g., KAZE. In some embodiments, the convolutional neural network for detecting keypoints is implemented in dedicated hardware (e.g., an FPGA or an ASIC). See, e.g., U.S. patent application Ser. No. 15/924,162, “SYSTEMS AND METHODS FOR IMPLEMENTING KEYPOINT DETECTION AS CONVOLUTIONAL NEURAL NETWORKS,” filed in the United States Patent and Trademark Office on Mar. 16, 2018, the entire disclosure of which is incorporated by reference herein.

In some embodiments, the sensing components of the display device system 400 include multiple calibrated cameras (e.g., a stereo depth camera system) for detecting the pose of the object 10 in the frame and, accordingly, a full six degree of freedom (6 DoF) pose estimate can be calculated of the display device system 400 with respect to the framed object 10. In some such embodiments, the data acquired by the multiple calibrated cameras are used to compute a 3-D point-cloud of the framed scene. The display device system 400 isolates the object being inspected from the background of the scene and aligns the isolated portion of the point cloud with the previously captured 3-D model using global or local alignment techniques such as the Iterative Closest Point (ICP) algorithm.

In embodiments of the present invention where the position of the camera of the sensing components of the display device system and the view of the object through the display device are not the same, the display device system 400 may also implement a compensation transformation. For example, in the case of the see-through display or displays of AR-HMD device, the cameras of the AR-HMD used to track the pose of the object may be located on the temples of the AR-HMD device, while user may view the object through the transparent displays of the AR-HMD device. As such, the pose of the object with respect to the cameras is different from the pose of the object with respect to the user's view of the object and therefore merely transforming the 3-D model based on the pose of the object calculated with respect to the cameras will result in a 3-D model that is misaligned from the user's actual view of the object. In some embodiments, the display device system computes the compensation transformation by considering the display or displays of the AR-HMD device a virtual camera or cameras (similar to active triangulation systems, see, e.g., Zanuttigh, P., et al., Time-of-Flight and Structured Light Depth Cameras. 2016, Springer.).

In more detail, an AR-HMD display generally includes two transparent displays (one for each eye). Accordingly, the display device system 400 calculates the pose of the object with respect to the view through each transparent displays such that the overlay is properly rendered for the geometry associated with each of the displays, thereby resulting in two different rendered images of the inspection information. For example, the inspection information may be rendered differently in accordance with a parallax transformation that allows the user to visualize the inspection information in the correct three-dimensional location, aligned with the object in the real world. This compensation for each display device (e.g., both the left eye and right eye display devices) causes the overlay to appear in the proper location in three-dimensional space for the user, and thereby improves the usability and user comfort in using the AR-HMD system for viewing inspection information about the object.

In operation 2250, the display device system 400 transforms the result 3-D model, which includes information about the locations of any defects, abnormalities, and other measurements of the object as computed by the inspection system 300 to align a rendering of the result 3-D model with the pose of the object through the view of the display 450 of the display device system 400.

After calculating a relative pose of the object viewed through the display device system 400, the 3-D model can be aligned with the view of the object (e.g., rigidly transformed or rotated) to compute an aligned 3-D model of the object being inspected. In some embodiments of the present invention, in operation 2250, the aligned 3-D model and its associated inspection information (or a portion of this information) are projected in the planes associated with the display or displays of the display device system (e.g., the display panel or the transparent displays of the AR-HMD system), in order to obtain an augmented reality (AR) visualization of the inspection results. For example, the AR visualization may include information about the likelihood that a defect is present in a particular set of small patches of surface of the object that overlays the inspection information with the view of the real world from the point-of-view of the inspector, as shown in FIG. 1.

This alignment is especially applicable for the inspection information that is location-specific on the object, e.g., the presence of defect on a portion of the fabric of the shoe in FIG. 1 because the inspection result data is combined with a live or substantially real-world view of the object. In some embodiments, non-location-specific inspection information, such as the computed identity or classification (e.g., the model of shoe) or the color, may be displayed in a dashboard or other user interface element that is not directly aligned with the three-dimensional location of the object in the real-world, as shown in the widget on the right side of FIG. 1 (e.g., in the right lens 454 of the head mounted display 450). In some embodiments, the non-location-specific information is shown in a user interface element that is placed adjacent the corresponding object, such as in a pop-up bubble that remains adjacent (e.g., to the side of) the object in the view of the object through the display 450.

In some embodiments of the present invention, values and numerical attributes that are localized to particular portions of the object may be characterized by a range output (e.g., numerical value falling within a particular range). For example, the numerical value may refer to a probability of a defect or a measure of a certain quantity, such as the smoothness of a surface. Accordingly, in some embodiments, the numerical value is depicted in the overlaid rendering of the result 3-D model based on a color. For example, according to one embodiment, the inspected quantity is characterized by a range of values that spans between a minimum and a maximum range and a location-specific value (e.g., a different value for each point in the 3-D point-cloud of the object being inspected). In order to visualize this information, in some embodiments a specific color is associated with each value of the considered range (e.g., the range of the inspected quantity is mapped onto a range of colors). In some embodiments, this color range is expressed in the form of a value on a grayscale, as a red, green, blue (RGB) triplet (3-tuple), or as an red, green, blue, alpha (RGBA) quadruple (4-tuple), where the alpha (A) channel controls the transparency of the color (e.g., in a range from completely transparent to complete opaque). In the case of a grayscale (or grayscale level) representation, in some embodiments, the range of the inspected quantity is mapped directly to the range of gray levels, such as by applying linear scaling, thresholding, or non-linear mapping, such as a gamma curve. In the case of an RGB triplet representation of the quantity, other mapping techniques may be used, such as the application of a heat color map (e.g., blue to yellow to red), a “jet” color map, a Parula color map (e.g., blue to green to yellow), or a color map corresponding to a single color (e.g., red) that varies in luminance or transparency (alpha) over the range of values. For example, to specifically highlight only those areas characterized by high values within the range (e.g., areas that are “most defective”), in some embodiments, the lower portions of the range (e.g., below a threshold value) are de-emphasized. In the example shown in FIG. 1, defective regions are presented using a cropped heat-map in which higher values of defects are presented in yellow to red, and lower values are not visualized (e.g., set to be completely transparent based on the value of an alpha channel), thereby resulting obtaining a partial transparency effect.

The operations of the method 2200 shown in FIG. 22, including the detecting the pose of the object 2210, computing the relative pose of the object with respect to the view of the object 2230, transforming the result 3-D model in accordance with the computed relative pose 2250, and generating the overlay data based on the transformed 3-D model and the computed pose of the object 2270, and subsequent display of the overlay data on the display 450 is repeated continuously or substantially continuously (e.g., at a real-time or substantially real-time frame rate, such as 30 frames per second or 60 frames per second). Accordingly, this maintains the overlay in association with the object as the object moves through the view through the display device. For example, as the object moves from a first side (e.g., left side) of the display toward a second side (e.g., right side) of the display, the overlaid inspection results (e.g., the heat map) moves with the object. Furthermore, if a human inspector picks up the object and rotates it, the result 3-D model is transformed in accordance with the changes in the relative pose between the object and the view through the display device, as detected by the sensing components of the display device system 400.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system for visual inspection, comprising:
a scanning system configured to capture images of an object and to compute a three-dimensional (3-D) model of the object based on the captured images;
an inspection system configured to:
compute a descriptor of the object based on the 3-D model of the object;
retrieve metadata corresponding to the object based on the descriptor; and
compute a plurality of inspection results based on the retrieved metadata and the 3-D model of the object; and
a display device system comprising:
a display;
a processor; and
a memory storing instructions that, when executed by the processor, cause the processor to:
generate overlay data from the inspection results; and
show the overlay data on the display, the overlay data being aligned with a view of the object through the display.

2. The system of claim 1, wherein the display device system comprises an augmented reality head-mounted device (AR-HMD) comprising the display, and
wherein the display is transparent to provide the view of the object.

3. The system of claim 2, wherein the AR-HMD comprises one or more sensing components configured to capture information about an environment near the AR-HMD and an orientation of the AR-HMD, and
wherein the memory further stores instructions that, when executed by the processor, cause the processor to:
compute a relative pose of the object with respect to the view of the object through the display of the AR-HMD based on the information from the sensing components; and
transform a position of the overlay data in the display in accordance with the relative pose of the object with respect to the view of the object through the display of the AR-HMD.

4. The system of claim 3, wherein the one or more sensing components comprise a depth camera.

5. The system of claim 3, wherein the memory further stores instructions that, when executed by the processor, cause the processor to:
detect a change in the relative pose of the object with respect to the view of the object through the display of the AR-HMD based on the information from the sensing components; and
transform the position of the overlay data in accordance with the change in the relative pose of the object with respect to the view of the object through the display of the AR-HMD.

6. The system of claim 3, wherein the display of the AR-HMD comprises a left lens and a right lens, and
wherein the instructions to transform the position of the overlay data comprise instructions that cause the processor to:
compute a first position of the overlay data in accordance with the relative pose of the object with respect to a first view of the object through the left lens of the display of the AR-HMD; and
compute a second position of the overlay data in accordance with the relative pose of the object with respect to a second view of the object through the right lens of the display of the AR-HMD.

7. The system of claim 1, wherein the display device system comprises a camera,
wherein the display comprises a display panel, and
wherein the memory further stores instructions that, when executed by the processor, cause the processor to:
control the camera to capture images of the object; and
show the captured images of the object on the display to provide the view of the object.

8. The system of claim 7, wherein the display device system comprises one or more sensing components configured to capture information about an environment near the camera, and
wherein the memory further stores instructions that, when executed by the processor, cause the processor to:
compute a relative pose of the object with respect to the view of the object through the display of the display device system based on the information from the sensing components; and
transform a position of the overlay data in the display in accordance with the relative pose of the object with respect to the view of the object through the display of the display device system.

9. The system of claim 8, wherein the memory further stores instructions that, when executed by the processor, cause the processor to:
detect a change in the relative pose of the object with respect to the view of the object through the display of the display device system based on the information from the sensing components; and
transform the position of the overlay data in accordance with the change in the relative pose of the object with respect to the view of the object through the display of the display device system.

10. The system of claim 8, wherein the one or more sensing components comprise the camera.

11. The system of claim 1, wherein the plurality of inspection results comprises defects detected by the inspection system.

12. The system of claim 11, wherein the inspection system is configured to detect defects by:
retrieving, from the metadata, one or more expected measurement values of the object;
measuring one or more measurement values of the 3-D model of the object;
comparing the one or more measurement values with corresponding ones of the one or more expected measurement values; and
detecting a defect when a measurement value of the one or more measurement values differs from a corresponding one of the one or more expected measurement values.

13. The system of claim 11, wherein the inspection system is configured to detect defects by:
retrieving, from the metadata, a reference 3-D model of a canonical instance of a class corresponding to the object;
aligning the 3-D model of the object with the reference 3-D model;
comparing the 3-D model of the object to the reference 3-D model to compute a plurality of differences between corresponding regions of the 3-D model of the object and the reference 3-D model; and
detecting one or more defects in the object when one or more of the plurality of differences exceeds a threshold.

14. The system of claim 13, wherein the comparing the 3-D model of the object to the reference 3-D model comprises:
dividing the 3-D model of the object into a plurality of regions;
identifying corresponding regions of the reference 3-D model;
detecting locations of features in the regions of the 3-D model of the object;
computing distances between detected features in the regions of the 3-D model of the object and locations of features in the corresponding regions of the reference 3-D model; and
outputting the distances as the plurality of differences.

15. The system of claim 13, wherein the reference 3-D model is computed by:
scanning a plurality of training objects corresponding to the class to generate a plurality of training 3-D models;
removing outliers from the plurality of training 3-D models to generate a plurality of typical training 3-D models; and
computing an average of the plurality of typical training 3-D models to generate the reference 3-D model.

16. The system of claim 11, wherein the inspection system is configured to detect defects by:
retrieving, from the metadata, a convolutional stage of a convolutional neural network and a defect detector;
rendering one or more views of the 3-D model of the object;
computing a descriptor by supplying the one or more views of the 3-D model of the object to the convolutional stage of the convolutional neural network;
supplying the descriptor to the defect detector to compute one or more defect classifications of the object; and
outputting the one or more defect classifications of the object.

17. The system of claim 11, wherein the inspection system is configured to detect defects by:
retrieving, from the metadata, one or more rules, each of the rules comprising an explicitly defined detector;
rendering one or more views of the 3-D model of the object; and
applying the explicitly defined detector of each of the one or more rules to the one or more views of the 3-D model of the object to compute one or more defect classifications of the object.

18. The system of claim 11, wherein the inspection system is configured to detect defects by:
retrieving, from the metadata, a generative model trained based on a plurality of training 3-D models of a representative sample of non-defective objects; and
supplying the 3-D model of the object to the generative model to compute one or more defect classifications of the object.

19. The system of claim 11, wherein the defects comprise location-specific defects,
wherein the inspection results comprise a result 3-D model, the result 3-D model identifying a location of at least one defect of the object, and
wherein the memory further stores instructions that, when executed by the processor, cause the processor to:
align the result 3-D model with the view of the object through the display; and
show the result 3-D model overlaid on the view of the object through the display.

20. The system of claim 19, wherein the result 3-D model indicates a magnitude of the at least one defect at the location, and
wherein the magnitude is shown as a color overlay on the view of the object through the display.

21. The system of claim 1, wherein the memory further stores instructions that, when executed by the processor, cause the processor to show non-location specific information of the inspection results in association with the view of the object through the display.

22. A method for visual inspection, comprising:
capturing a plurality of images of an object using a scanning system;
computing a three-dimensional (3-D) model of the object based on the plurality of images;
computing, by an inspection system comprising a processor and memory, a descriptor of the object based on the 3-D model of the object;
retrieving, by the inspection system, metadata corresponding to the object based on the descriptor;
computing, by the inspection system, a plurality of inspection results based on the retrieved metadata and the 3-D model of the object;
generating overlay data from the inspection results; and
showing the overlay data on a display of a display device system, the overlay data being aligned with a view of the object through the display.

23. The method of claim 22, wherein the display device system comprises an augmented reality head-mounted device (AR-HMD) comprising the display, and
wherein the display is transparent to provide the view of the object.

24. The method of claim 23, wherein the AR-HMD comprises one or more sensing components configured to capture information about an environment near the AR-HMD and an orientation of the AR-HMD, and
wherein the method further comprises:
computing, by the display device system, a relative pose of the object with respect to the view of the object through the display of the AR-HMD based on the information from the sensing components; and
transforming a position of the overlay data in the display in accordance with the relative pose of the object with respect to the view of the object through the display of the AR-HMD.

25. The method of claim 24, wherein the one or more sensing components comprise a depth camera.

26. The method of claim 24, further comprising:
detecting a change in the relative pose of the object with respect to the view of the object through the display of the AR-HMD based on the information from the sensing components; and
transforming the position of the overlay data in accordance with the change in the relative pose of the object with respect to the view of the object through the display of the AR-HMD.

27. The method of claim 24, wherein the display of the AR-HMD comprises a left lens and a right lens, and
wherein the transforming the position of the overlay data comprises:
computing a first position of the overlay data in accordance with the relative pose of the object with respect to a first view of the object through the left lens of the display of the AR-HMD; and
computing a second position of the overlay data in accordance with the relative pose of the object with respect to a second view of the object through the right lens of the display of the AR-HMD.

28. The method of claim 22, wherein the display device system comprises a camera,
wherein the display comprises a display panel, and
wherein the method further comprises:
controlling the camera to capture images of the object; and
showing the captured images of the object on the display to provide the view of the object.

29. The method of claim 28, wherein the display device system comprises one or more sensing components configured to capture information about an environment near the camera, and
wherein the method further comprises:
computing a relative pose of the object with respect to the view of the object through the display of the display device system based on the information from the sensing components; and
transforming a position of the overlay data in the display in accordance with the relative pose of the object with respect to the view of the object through the display of the display device system.

30. The method of claim 29, further comprising:
detecting a change in the relative pose of the object with respect to the view of the object through the display of the display device system based on the information from the sensing components; and
transforming the position of the overlay data in accordance with the change in the relative pose of the object with respect to the view of the object through the display of the display device system.

31. The method of claim 29, wherein the one or more sensing components comprise the camera.

32. The method of claim 22, wherein the plurality of inspection results comprises defects detected by the inspection system.

33. The method of claim 32, wherein the inspection system detects defects by:
retrieving, from the metadata, one or more expected measurement values of the object;
measuring one or more measurement values of the 3-D model of the object;
comparing the one or more measurement values with corresponding ones of the one or more expected measurement values; and
detecting a defect when a measurement value of the one or more measurement values differs from a corresponding one of the one or more expected measurement values.

34. The method of claim 32, wherein the inspection system detects defects by:
retrieving, from the metadata, a reference 3-D model of a canonical instance of a class corresponding to the object;
aligning the 3-D model of the object with the reference 3-D model;
comparing the 3-D model of the object to the reference 3-D model to compute a plurality of differences between corresponding regions of the 3-D model of the object and the reference 3-D model; and
detecting one or more defects in the object when one or more of the plurality of differences exceeds a threshold.

35. The method of claim 34, wherein the comparing the 3-D model of the object to the reference 3-D model comprises:
dividing the 3-D model of the object into a plurality of regions;
identifying corresponding regions of the reference 3-D model;
detecting locations of features in the regions of the 3-D model of the object;
computing distances between detected features in the regions of the 3-D model of the object and locations of features in the corresponding regions of the reference 3-D model; and
outputting the distances as the plurality of differences.

36. The method of claim 34, wherein the reference 3-D model is computed by:
scanning a plurality of training objects corresponding to the class to generate a plurality of training 3-D models;
removing outliers from the plurality of training 3-D models to generate a plurality of typical training 3-D models; and
computing an average of the plurality of typical training 3-D models to generate the reference 3-D model.

37. The method of claim 32, wherein the inspection system detects defects by:
retrieving, from the metadata, a convolutional stage of a convolutional neural network and a defect detector;
rendering one or more views of the 3-D model of the object;
computing a descriptor by supplying the one or more views of the 3-D model of the object to the convolutional stage of the convolutional neural network;
supplying the descriptor to the defect detector to compute one or more defect classifications of the object; and
outputting the one or more defect classifications of the object.

38. The method of claim 32, wherein the inspection system detects defects by:
retrieving, from the metadata, one or more rules, each of the rules comprising an explicitly defined detector;
rendering one or more views of the 3-D model of the object; and
applying the explicitly defined detector of each of the one or more rules to the one or more views of the 3-D model of the object to compute one or more defect classifications of the object.

39. The method of claim 32, wherein the inspection system detects defects by:
retrieving, from the metadata, a generative model trained based on a plurality of training 3-D models of a representative sample of non-defective objects; and
supplying the 3-D model of the object to the generative model to compute one or more defect classifications of the object.

40. The method of claim 32, wherein the defects comprise location-specific defects,
wherein the inspection results comprise a result 3-D model, the result 3-D model identifying a location of at least one defect of the object, and
wherein the method further comprises:
aligning the result 3-D model with the view of the object through the display; and
showing the result 3-D model overlaid on the view of the object through the display.

41. The method of claim 40, wherein the result 3-D model indicates a magnitude of the at least one defect at the location, and
wherein the magnitude is shown as a color overlay on the view of the object through the display.

42. The method of claim 22, further comprising showing non-location specific information of the inspection results in association with the view of the object through the display.
